(19) United States
(12) Patent Application Publication
(10) Pub. No.: US 2007/0038547 A1
(43) Pub. Date: Feb. 15, 2007

(54) Method of consolidating independent owners of distribution warehouses into an investment corporation

(75) Inventor: Frederic Speed Bancroft, Monroe, LA (US)

Correspondence Address: PERRET DOISE;A PROFESSIONAL LAW CORPORATION, P.O. DRAWER 3408, LAFAYETTE, LA, 70502-3408, US

(73) Assignee: Bancroft Enterprises, Inc.

(21) Appl. No.: 11/542,794

(22) Filed: Oct. 4, 2006

Related U.S. Application Data
(63) Continuation-in-part of application No. 10/987,903, filed on Nov. 12, 2004.
Application No. 10/987,903 is a continuation-in-part of application No. 10/612,630, filed on Jul. 1, 2003.

(51) Int. Cl. G06Q 40/00

(52) U.S. Cl. 705/36 R

(57) ABSTRACT

Methods of consolidating independent owners of distribution warehouses into an investment corporation for purposes of achieving economics of scale, for obtaining favorable mortgage financing and for creating a vehicle to enable periodic refinancing and investment of proceeds from such refinancing in real estate opportunities. The investment corporation is formed and independent owners of distribution warehouses are assembled and selected to participate in the investment corporation. The participants' retain ownership of their warehouse but lease the warehouses to the investment corporation that in turn sub-leases the warehouses back to each participant and agrees to pay the participant's mortgage financing for the warehouse. The participants agree to pay rent to the investment corporation, which is used by the investment corporation to pay the mortgage financing and to acquire income-producing investments that may distributed to the participants in the form of a dividend.

### CROSS REFERENCE TO RELATED APPLICATIONS

This application is a continuation-in-part of application Ser. No. 10/987,903, filed Nov. 12, 2004, which is a continuation-in-part of application Ser. No. 10/612,630, filed Jul. 1, 2003, the entire contents of which are incorporated by reference herein.

### FIELD OF THE INVENTION

The present invention relates generally to a method of consolidating independent owners of distribution warehouses into either a Real Estate Investment Trust (REIT) or an investment corporation for purposes of achieving financial and investment benefits which otherwise would not be available to any one individual warehouse owner, and more particularly for purposes of obtaining economies of scale, including favorable mortgage financing, and for creating a vehicle to enable periodic refinancing and investment of proceeds from the refinancing in real estate and other investment opportunities that produce net earnings, which may be distributed to the REIT's or investment corporation's participants.

### BACKGROUND OF THE INVENTION

The Real Estate Investment Trust Act of 1960 propagated laws for the establishment of Real Estate Investment Trusts otherwise known as REITs. A REIT is a company dedicated to owning and operating income producing real estate, such as apartments, shopping centers, and offices. Some REITs finance real estate.

Congress created REITs to permit small investors to make investments in large-scale, income producing real estate. The REIT allowed small investors to pool their investments to acquire large real estate holdings.

When first established, REITs could only own real estate. They could not operate or manage it. This caused REITs to find third-parties to operate and manage the REIT's commercial real estate. But, third-party managers often were viewed as having economic interests diverse from those of the REIT's owners. Investors saw this as a disadvantage. REITs therefore played a limited role in real estate investments until 1986.

In 1986, Congress passed a tax reform act which permitted REITs not only to own income producing commercial properties but to operate and manage them. The law also put an end to real estate tax shelters that had attracted much of the capital from investors, not for the income they produced, but for the losses sustained and passed onto the investors. The change in the law caused real estate investment to focus on producing income.

Under current law, a company can qualify as a REIT if it complies with provisions of the Internal Revenue Code that requires REITs to:
1. Be taxable as a corporation;
2. Be managed by a board of directors or trustees;
3. Have shares that are fully transferable;
4. Have a minimum of 100 shareholders;
5. Have no more than 50% of the shares held by five or fewer individuals during the last half of each taxable year;
6. Invest at least 75% of total assets in real estate assets;
7. Derive at least 75% of gross income from rents from real property, or interest on mortgages on real property;
8. Have no more than 20% of its assets consist of stocks and taxable REIT subsidiaries;

and
9. Pay annual shareholder dividends of at least 90% of its taxable income.

REITs are attractive to investors because of their liquidity. Investors can buy and sell interest in diversified portfolios of property simply by buying and selling shares of the REIT. REITs are also considered to be relatively safe and conservative investments because information about the company, its property, the management, and its business plan are usually available, particularly if the REIT is traded publicly. REITs have also shown favorable performance on the stock market.

REITs are classified into three types:
1. Equity REITs that own and operate income producing real estate;
2. Mortgage REITS that lend money directly to real estate owners and operators or extend credit indirectly through the acquisition of loans or mortgage backed securities; and
3. Hybrid REITs which both own property and make loans to real estate owners and operators.

REITs are managed by corporate officers who are accountable to the board of directors as well as the REIT's shareholders and creditors.

U.S. Pat. No. 6,292,788 and U.S. Published Patent Application 0013750 disclose investment methods using REITs by dividing investment real estate into a plurality of tenant-in-common deeds of predetermined denominations that are subject to a master agreement and a master lease to form deedshares. Holders of the deedshares receive an income stream from the master lease without having to manage or maintain the real estate. The master tenant may also purchase the holders'deedshares at the end of a specified term, which further may provide income to the holders.

The method of the present invention differs from prior investment mechanisms involving REITs or other investment entities by providing a unique method of consolidating independent owners of distribution warehouses into either a REIT or investment corporation to achieve numerous financial and investment benefits which otherwise would not be available to any one individual warehouse owner.

### SUMMARY OF INVENTION

It is an object of the present invention to monetize the fair market value of a participant's distribution warehouse to create cash reserves that may be used by the participant for working capital and future needs of the distribution company, to strengthen the participant's credit line and that of the distribution company, and to improve the participant's financial condition and the financial condition of the distribution company, as for example, by eliminating debt (and saving interest expense) and by purchasing income producing securities and investments.

It is a further object of the present invention to permit the participant to acquire ownership of the REIT or investment corporation through participation and without the expenditure of money or other compensation for such ownership; neither will the participant be required to guarantee debt of the REIT or investment corporation, lend funds to the REIT or investment corporation, nor assume any direct or contingent liability for ownership of the REIT or investment corporation.

It is a further object of the present invention to provide cash income to the participants through mandatory REIT distributions of at least 90% of net earnings or in the case of the investment corporation, through dividend payments of a portion of the net earnings.

It is a further object of the present invention to provide a mechanism through which the REIT or investment corporation acquires income producing real estate and other investment assets by means of periodic re-financing of the distribution warehouses.

It is a further object of the present invention to have the REIT or investment corporation secure non-recourse financing to fund its operations and to acquire income producing assets without pledging the REIT's or investment corporation's stock, without pledging a corporate participant's assets or stock, without requiring an individual participant's personal endorsement or guaranty, and without encumbering a participant's line of credit.

It is a further object of the present invention to free the participants from managing the operations of the REIT by instilling such duties in a manager who is supervised by the REIT's Board of Directors or in the case of the investment corporation, by instilling such duties in a management company which is overseen by the Board of Directors of the investment corporation.

It is a further object of the present invention to cap the REIT's or investment corporation's administrative expenses by dedicating a fixed portion of the rent paid to the REIT or investment corporation for such administrative expenses; in this manner the REIT or investment corporation will never be overburdened with excessive costs or expenses to dilute earnings. Such fixed overhead expenses will enhance the price of the REIT's stock if publicly traded.

It is a further object of the present invention to lease the distribution warehouses to the participants after purchase by the REIT or investment corporation at competitive market rates or lower, which is made possible by the unique financing of the REIT or investment corporation and through the consolidation of a large number of warehouses. Low rents offer a savings to the participants that add to their bottom line; for example, a participant with a 60,000 square foot warehouse paying $4.75 per square foot as rent will save $1.00 per square foot, or $60,000 per year, because the REIT or investment corporation is able to offer the warehouse to the participant at $3.75 per square foot.

It is a further object of the present invention to provide a faster amortization rate of financing without a corresponding increase in rent to satisfy the financing's debt service; this results in a shortened period for payment of the debt service and re-mortgaging of the warehouses. The REIT or investment corporation is able to achieve a higher growth rate with increased earnings and a greater pay out to the participants. The higher growth rate and earnings will enhance the REIT's stock prices should the REIT be publicly traded.

It is a further object of the present invention to obtain better financing rates and terms with unencumbered collateral, which over time will enhance the REIT's or investment corporation's position to negotiate loans at even better rates and terms.

It is a further object of the present invention to grow the REIT or investment corporation by acquiring income producing real estate assets or other investment assets without leveraging these acquired assets; net earnings from the acquired assets will not be burdened with interest and the net income will be available to distribution to the participants of the REIT or investment corporation.

It is a further object of the present invention to establish a unique lessor-lessee relationship unlike the typical situation where the REIT or investment corporation would have to acquire leases on the open market by negotiating with third-party lessees; under the present invention, the REIT or investment corporation and each participant are lessor and lessee, which results in a controlled rent and a controlled stream of rental income which will be unique to the REIT vis-à-vis all other REITs or unique to the investment corporation vis-à-vis all other investment companies. This controlled rent will provide a certain stream of income to be capitalized by mortgage financing in the form of additional income producing real estate assets or other investment assets, all of which will allow net income for distribution to the REIT's or investment corporation's owners (the participants) in a sure and highly predictable manner.

It is a further object of the present invention to effect an initial public offering (IPO) of shares of the REIT, which will provide liquidity of ownership in the REIT, equity valuation (recorded on a day-to-day basis), and additional capital funds to grow the REIT.

It is a further object of the present invention to permit the participant in the investment corporation to retain ownership of its distribution warehouse by leasing the warehouse to the investment corporation in consideration of the investment corporation's agreements to sub-lease the warehouse back to the participant and to pay the participant's mortgage financing (principal and debt service) associated with the warehouse.

These objects and advantages are realized by providing a novel method of consolidating independent owners of distribution warehouses into a REIT. As part of the method of the present invention, the REIT is formed. A group of independent owners of distribution warehouses willing to participate in ownership of the REIT is assembled. Participants in the REIT are selected from the group of independent owners of distribution warehouses.

As part of or in connection with the selection of the participants, each participant enters into a sale-leaseback agreement with the REIT. The sale-leaseback agreement preferably has terms obligating each participant to sell the participant's warehouse to the REIT and lease it back. The sales price is set at an appraised fair market value of the participant's warehouse. The sale-leaseback agreement may also have terms obligating the participant to lease the warehouse from the REIT after the warehouse is sold to the REIT under a lease agreement. Preferably, the lease agreement provides for a triple-net lease.

The terms of the sale-lease agreement may also require the participant to pay rent to the REIT. Preferably, the rent is determined by a standard formula that charges a uniform rate per square footage of the warehouse so that the participant knows in advance what rent the participant will be required to pay and to assure that the participant's rental rate per square foot is the same rental rate paid by the other participants. The sale-leaseback agreement may also have terms obligating the participant to renew the lease on a periodic basis. Preferably, the participant is obligated to renew the lease at least every seven to ten years and more preferably every seven or ten years.

Each participant's warehouse is appraised to determine its appraised fair market value. Preferably, the appraisal is conducted by at least one appraiser. It is preferred if the appraiser is selected by a lender who issues a non-recourse mortgage loan to the REIT as described below. Each participant pays for the cost of the appraisal for the participant's warehouse and the cost of environmental remediation if so required.

Title in each participant's warehouse is transferred to the REIT. Preferably, title transfer is accomplished when the REIT purchases the warehouse from the participant by paying to the participant the appraised fair market value of the warehouse. After transferring title, each participant continues to pay maintenance expenses, insurance, and/or ad valorum taxes accruing from the participant's warehouse.

If before transferring title to the REIT, a participant has entered into a lease for the participant's warehouse with a distribution company controlled by the participant (e.g., a distribution company in which the participant is a majority shareholder or owner), the lease is preferably cancelled before the participant transfers title to the REIT. This way the warehouse is transferred to the REIT unencumbered by a lease so that the REIT and the participant are free to enter into the lease under the lease agreement with each other as described above.

The REIT purchases each participant's warehouse preferably for a cash payment made to the participant. It is preferred if the amount of the cash payment is 70%-80% of the appraised fair market value of the participant's warehouse. This leaves a balance owed to the participant. The REIT may issue a secured note payable to the participant for the balance owed. It is preferred if the secured note provides that the REIT will pay interest accruing on the balance owed to the participant. Preferably, the interest is paid in monthly installment payments. The secured note may also provide that the REIT will pay the balance owed to the participant in full at the time the REIT obtains a new non-recourse mortgage loan, which preferably is at the end of an initial lease term of at least seven to ten years and more preferably seven-years or ten-years.

Interest in the secured note may be set at one percent above a prime rate that exists when the REIT issues the secured note. Preferably, the prime rate is the prime rate published in the Wall Street Journal. It is also preferred if the secured note is secured by a second lien on the participant's warehouse. The second lien maybe recorded in an appropriate depository or registry to comply with applicable legal recordation requirements.

In accordance with the method of the present invention, the REIT agrees to lease to each participant the warehouse the participant sold to the REIT. Preferably, the REIT and each participant enter into a lease agreement for the specific warehouse. It is preferred if the lease agreement has terms obligating the participant to pay rent to the REIT. The lease agreement preferably is for a term of at least seven to ten years and more preferably seven or ten years. It is also preferred if the lease agreement is a triple-net lease so that the cumulative rent paid by the participants to the REIT equals or is greater than a scheduled debt service on the non-recourse mortgage loan issued to the REIT as discussed below.

In accordance with the method of the present invention, the sale-leaseback agreement and/or the lease agreement specifies a standard formula to compute the rent. Preferably, the standard formula charges a uniform rate per square footage of the warehouse so that the participant knows before they sign the sale-lease agreement and/or the lease agreement what specific annual rent the participant will be required to pay.

Preferably, the rent is established by determining an annual debt service amount for the non-recourse mortgage loan that has or will be issued to the REIT as described below. The total square footage of all the warehouses leased or to be leased by the REIT is determined. The annual debt service amount is divided by the total square footage to derive a first component price per square foot. A second component and a third component are then added to the first component. The second component is preferably an amount dedicated for use by the REIT to pay for general and administrative expenses of the REIT. The third component is preferably an amount dedicated for use by the REIT as working capital and to permit the REIT to make interest payments and cash distributions to each participant.

The addition of the second and third components to the first component results in a formula rental price per square foot. The formula rental price per square foot is multiplied by the square footage of the warehouse leased to the participant to derive the annual rent to be paid by the participant to the REIT. It is preferred if the second component is at least 50 cents per square foot. It is also preferred if the third component is at least 25 cents per square foot.

It is preferred if each sale-leaseback agreement and lease agreement are contemporaneously entered into by the REIT and each participant.

The method of the present invention may also include issuing a non-recourse mortgage loan to the REIT. Preferably, the non-recourse mortgage loan is issued by a lender. It is preferred if the non-recourse mortgage loan is issued for a loaned amount capable of financing at least a portion of the REIT's purchase of the warehouses and preferably the portion constituting the REIT's cash purchase or cash payment to the participant.

The non-recourse mortgage loan may be issued under terms obligating the REIT to make installment payments of principal and interest to the lender on the loaned amount. The REIT may use the rent paid by the participants under the leases to make the installment payments to the lender. Preferably, the non-recourse mortgage loan has a term of at least seven to ten years and more preferably a term of seven or ten years. It is also preferred if the non-recourse mortgage loan is serviced on at least a seven to ten year debt payment schedule and more preferably a seven-year or ten-year debt payment schedule.

The lender may require the REIT to pledge the warehouses and/or an assignment of the lease agreements as collateral for the non-recourse mortgage loan. The lender will have a first primary lien on the warehouses.

The REIT may use the non-recourse mortgage loan to finance the cash payment made by the REIT to the participants to purchase their warehouses.

As part of the method of the present invention, an ownership interest in the REIT is transferred to each participant. Preferably, each participant's ownership interest in the REIT is a prorata share of the outstanding shares of the REIT. The participant's prorata ownership share is calculated by dividing the appraised fair market value of the warehouse the participant sold or will sell to the REIT by the total appraised fair market value of all warehouses sold or to be sold to the REIT by all participants.

Under the method of the present invention, each warehouse owned by the REIT may be reappraised to determine the warehouse's reappraised fair market value. The reappraised fair market value of each warehouse is added together and used to calculate the total reappraised fair market value of all of the REIT's warehouses. Preferably, the reappraisal of each warehouse is conducted by at least one appraiser selected by a lender who issues a new non-recourse mortgage loan to the REIT as described below. It is preferred if the REIT pays for the cost of reappraising the warehouses.

The method of the present invention may include renewing each lease agreement entered into between the REIT and the participants. Preferably, the lease agreements are renewed for at least an additional seven to ten year term and more preferably for an additional seven or ten year term, with rental prices re-calculated on the same formula basis.

In accordance with the method of the present invention, a new non-recourse mortgage loan is issued to the REIT for a loaned amount that is 70%-80% of the total reappraised fair market value of all of the warehouses. Preferably, the new non-recourse mortgage loan is issued by a lender. The new non-recourse mortgage loan may provide proceeds to the REIT.

The REIT invests the proceeds provided by the new non-recourse mortgage loan in at least one investment capable of producing investment revenue. It is preferred if the proceeds of the new non-recourse mortgage loan are invested in a variety of multiple investments. Preferably, the REIT's Board of Directors selects the investments. It is preferred if the investments include income producing real estate. The REIT preferably distributes at least 90% of net earnings from the investment revenue produced by the investment to the participants. Preferably, 90% of the net earnings are distributed by the REIT to the participants annually.

Preferably, the events of (1) reappraising each warehouse, (2) renewing each lease agreement, (3) issuing new non-recourse mortgage loan to the REIT, and (4) investing the proceeds from the new non-recourse mortgage loan, occur on a periodic basis, as for example, at least every seven to ten years or every seven or ten years.

In another embodiment of the present invention, a manager is employed by and/or for the REIT. The manager may be responsible for general and administrative operations of the REIT, including managing the real estate investment assets owned by the REIT. It is preferred if the manager acquires an ownership interest in the REIT.

The REIT may pay the manager an annual management fee. It is preferred if the management fee is an amount, preferably a fixed amount, that is computed by multiplying the second component price per square foot (e.g. 50 cents per square foot) by the total square footage of all the warehouses owned or to be owned by the REIT.

It is preferred if the manager has a one-percent ownership interest in the REIT. In this instance, each participant's ownership interest in the REIT will be a prorata share of the outstanding or remaining 99% interest of the REIT. Each participant's prorata ownership share of the REIT maybe calculated by dividing the appraised fair market value of the warehouse sold or to be sold by the participant to the REIT by the total appraised fair market value of all of the warehouses sold or to be sold by the participants to the REIT.

In another embodiment of the present invention, the REIT may purchase and obtain title to any leasehold improvement made by the participant to the leased warehouse during the term of the lease agreement. It is preferred if the REIT pays the participant an amount that is or constitutes the participant's original cost for the leasehold improvement. It is also preferred if the REIT's purchase of the leasehold improvement is accomplished at the time the lease agreement is renewed.

In a further embodiment of the present invention, an initial public offering of REIT's stock may be made. It is preferred that the stock is publicly offered on a recognized stock exchange. It is also preferred if the initial public offering is approved by the Board of Directors of the REIT.

In an alternative embodiment, the method of the present invention provides for the consolidation of independent owners of distribution warehouses into an investment corporation rather than a REIT. The investment corporation is preferably a privately held sub-chapter C corporation.

All processes applicable to the REIT would also apply to the investment corporation including the methods of acquiring participants, warehouses, rental agreements, financing, and the like. However, unlike the REIT, the investment corporation would not be required to pay out 90% of net earnings to the participants annually. The investment corporation preferably would from time to time, as desired, pay out dividends to participants, but the primary purpose of the investment corporation would be to make sound and profitable investments. It is also preferred that the investment corporation remains a privately held corporation.

It is preferred that the financing for the investment corporation constitute a ten-year term loan. The loaned amount will be 80% of the appraisal value of the warehouses. The investment corporation would sign a secured note with each participant for the remaining 20%. Preferably, 100% financing will be obtained.

The cash flow in the investment corporation would first be directed to paying any administrative expenses of the investment corporation, corporate taxes, and then the participants' notes. After the participants' notes have been completely paid off by the investment corporation, the investment corporation would begin to make investments. Any kind of capital investments could be made. Examples of investments would include investments in timberland which has been known to accrue appreciation value in reasonable numbers and which also generates income from the sale of timber. Hunt clubs could also be formed and paid hunts on the timberland would provide additional income.

The investment corporation's investment strategy would be to take the time to make profitable investments. The investment corporation would not be subject to pressure to perform that would normally be present with respect to publicly traded REITs. The cash flow of the investment corporation could be placed in money market accounts and other investment opportunities to build a diversified portfolio of investments and assets.

The investment corporation could pay cash dividends from time to time from the net earnings of its investments; however, that is not the primary purpose of the investment corporation. The net cash flow of the investment corporation would be used primarily to make investments as such investments and opportunities present themselves. The investment corporation will preferably be governed by a Board of Directors which will be composed of participants. The participants will control the investment corporation, but the operations and administration of the investment corporation will be conducted by a management company that will report to the Board of Directors of the investment corporation.

The investment corporation preferably will retain all options that are open to it including the opportunity to sell the entire investment corporation or sell certain assets of the investment corporation. For example, the investment corporation could sell warehouses to a REIT and still maintain its other assets. As consideration for the sale, the investment corporation could receive stock of a publicly traded REIT and then dividend the stock to the participants so that they own the REIT stock personally. Dividends from investment corporations have favorable tax treatment due to recent changes in the tax law governing dividends from corporations. Additionally, the investment corporation could, for example, trade timberland for stock in a publicly traded REIT, which stock could be divided to the participants of the investment corporation. A further option would be to bring additional participants into the investment corporation with contribution of the warehouses by exchanging stock for the warehouses or arranging for the financing of the warehouses in giving the owners or participants operating interest in the investment corporation or preferred stock.

The investment corporation preferably would be audited on an annual basis and the participants would have full access to the investment corporation's business records. The participants could conduct their own private investigation into the investment corporation using their own experts such as a CPA. The same auditing could be conducted of the management company which manages the investment corporation. The participants would preferably be allowed to have access to the business records of the management company.

The investment corporation preferably pays an administrative fee to the management company. All administrative costs for operating the investment corporation will be borne by the management company with only extraordinary transactional fees or other fees paid by the investment corporation. For example, if the investment corporation wished to exchange timberland for REIT stock, the transactional costs of doing this will be borne by the investment corporation.

Investments made by the investment corporation would be subject to careful review of the investment corporation's Board of Directors or of certain individuals appointed by the Board to oversee such investment activities. It would be the responsibility of the management company to bring investment opportunities to the attention of the Board. The Board could also present its own investment opportunities.

If a participant in the investment corporation had an interest in divesting the participant's ownership interest in the investment corporation, the participant may do so by means of redeeming the participant's ownership interest or stock in the investment corporation at any independently appraised price. The stock price will be paid in such a manner that it would be feasible for the investment corporation and advantageous to the participant. The participant's ownership interest in the investment corporation could also be passed to the participant's heirs under appropriate state laws provided there are no adverse tax consequences.

In another alternative embodiment of the method of the present invention, the participants do not enter into the sale-leaseback agreements with the investment corporation. Instead, each participant leases its warehouse to the investment corporation in exchange for the investment corporation's agreement to pay the debt service (including principal and interest) on any mortgage financing for the warehouse the participant has at the time the participant leases the warehouse to the investment corporation or any mortgage financing that the participant may later acquire on the warehouse.

The investment corporation does not assume the participant's mortgage financing but agrees to pay the participant's debt service on the mortgage financing. The debt on the mortgage financing remains on the participant's books. Each participant is therefore able to show its mortgage debt on its balance sheet.

The investment corporation also agrees to sub-lease the participant's warehouse to the participant. The participant agrees to pay a competitive market rent to the investment corporation. The sub-lease is triple-net. Each participant preferably pays a competitive market rent to the investment corporation that may be in the range of $3.00 to $6.00 per square foot of warehouse per year depending on the location, or possibly even higher than $6.00/sq.ft. per year or lower than $3.00/sq.ft. per year. For example, if the warehouse is owned in a high rent area like New York City, the rent will be higher than one located in Corpus Christi, Texas. The cash flow created by the rent is used by the investment corporation to pay the participant's mortgage financing and to acquire and purchase income producing investments such as income producing real estate properties. The concept of this alternative embodiment is to create strong cash flow from a consolidation of the warehouses into one company with which to build real estate properties in the investment corporation. The method of acquiring ownership in the investment corporation is the same as before, based on pro rata appraised values of the warehouses in question.

If at the time the participant leases its warehouse to the investment corporation the participant has no mortgage financing on its warehouse, the participant will receive a larger ownership percentage in the investment corporation than it otherwise would have received if its warehouse had been burdened with mortgage financing and debt. This occurs because the participant's appraised fair market value of its warehouse (which determines the participant's ownership percentage in the investment corporation) will be greater than an appraised fair market value of the participant's warehouse burdened by or encumbered with mortgage debt.

The REIT or investment corporation may be created and/or operated as described herein through the use of a computer system and computer applications, including a database containing the REIT's or investment corporation's business, financial, and investment records, as for example, sale-leaseback agreements, lease agreements, investments, investment revenue, proceeds, net earnings, and distributions made to the participants.

The computer system may include a CPU which executes instructions that implement the database server application and stores information. The computer system may preferably include network interface so that the database may be accessed through other computers on a local area network. The computer system also preferably includes a communication device, e.g. a telephone modem, a cable modem, a DSL modem, or other similar device, capable of communicating data between computers on a systems and a wide area network. The communication devices may be used to connect the computer system through the internet or intranet in order to permit users at remote locations to access data in the database. A printer or printers may be connected to the computer system to create database reports.

### BRIEF DESCRIPTION OF THE DRAWINGS

FIG. 1 is flowchart depicting the steps of forming the REIT, assembling a group of independent owners of distribution warehouses, selecting participants in the ownership of the REIT, and appraising each participant's warehouse, which steps form part of an embodiment of the method of the present invention.

FIG. 2 is a flowchart depicting the further steps of transferring title in each warehouse from the participants to the REIT and leasing the warehouses after transfer back to the participants, which steps form part of the embodiment of the method of the present invention.

FIG. 3 is a flowchart depicting the further step of issuing a non-recourse mortgage loan to the REIT, which step forms part of the embodiment of the method of the present invention.

FIG. 4 is a flowchart depicting the further steps of transferring ownership in the REIT to the participants, reappraising each warehouse, and renewing each lease agreement, which steps form part of the embodiment of the method of the present invention.

FIG. 5 is a flowchart depicting the further steps of issuing a new non-recourse mortgage loan to the REIT, investing proceeds from the new non-recourse mortgage loan, and distributing at least 90% of net earnings from the investments to the participants, which steps form part of the embodiment of the method of the present invention.

FIG. 6 depicts the terms of the sale-leaseback agreement, which may be included as part of the embodiment of the method of the present invention.

FIG. 7 depicts the terms of the lease agreement, which may be included as part of the embodiment of the method of the present invention.

FIG. 8 depicts the procedure that may be used to establish the rent to be paid by the participants, which may be included as part of the embodiment of the method of the present invention.

FIG. 9 depicts an alternative step of employing a manager for the REIT, which step may be included as part of the embodiment of the method of the present invention.

FIG. 10 depicts alternative step of the REIT purchasing leasehold improvements made by the participants, which step may be included as part of the embodiment of the method of the present invention.

FIG. 11 depicts an alternative step of the REIT's stock being subject to an IPO, which step may be included as part of the embodiment of the method of the present invention.

FIG. 12 is a flow chart depicting the steps of forming the investment corporation, assembling a group of independent owners of distribution warehouses, selecting participants in the ownership of the investment corporation, and appraising each participant's warehouse, which steps form part of an alternative embodiment of the method of the method of the present invention.

FIG. 13 is a flow chart depicting the further steps of the alternative embodiment which include transferring title in each warehouse from the participants to the investment corporation and leasing the warehouses after a transfer back to the participants.

FIG. 14 is a flow chart depicting the further step of the alternative embodiment of the present invention which includes issuing a non-recourse mortgage loan to the investment corporation.

FIG. 15 is a flow chart depicting the further steps of the alternative embodiment of the present invention which include transferring ownership in the investment corporation to the participants, reappraising each warehouse, and renewing each lease agreement.

FIG. 16 is flow chart depicting the further steps in the alternative embodiment of the present invention which include issuing a new non-recourse mortgage loan to the investment corporation, investing proceeds from the new non-recourse mortgage loan, and distributing a portion of net earnings from the investments to the participants.

FIG. 17 depicts the terms of the sale-lease back agreement in the alternative embodiment of the present invention.

FIG. 18 depicts the terms of the lease agreement in the alternative embodiment of the present invention.

FIG. 19 depicts the procedure that may be used to establish the rent to be paid by the participant in the alternative embodiment of the present invention.

FIG. 20 depicts the step of employing a management company for the investment corporation in the alternative embodiment of the present invention.

FIG. 21 depicts the step of the investment corporation purchasing leasehold improvements made by the participants in the alternative embodiment of the present invention.

FIG. 22 depicts a further alternative embodiment of the method of the present invention where the participant-instead of selling its warehouse to the investment corporation-leases its warehouse to the investment corporation, and in exchange, the investment corporation sub-leases the warehouse back to the participant and pays the principal and debt service of the participant's mortgage financing for the warehouse.

### DETAILED DESCRIPTION OF PREFERRED EMBODIMENTS

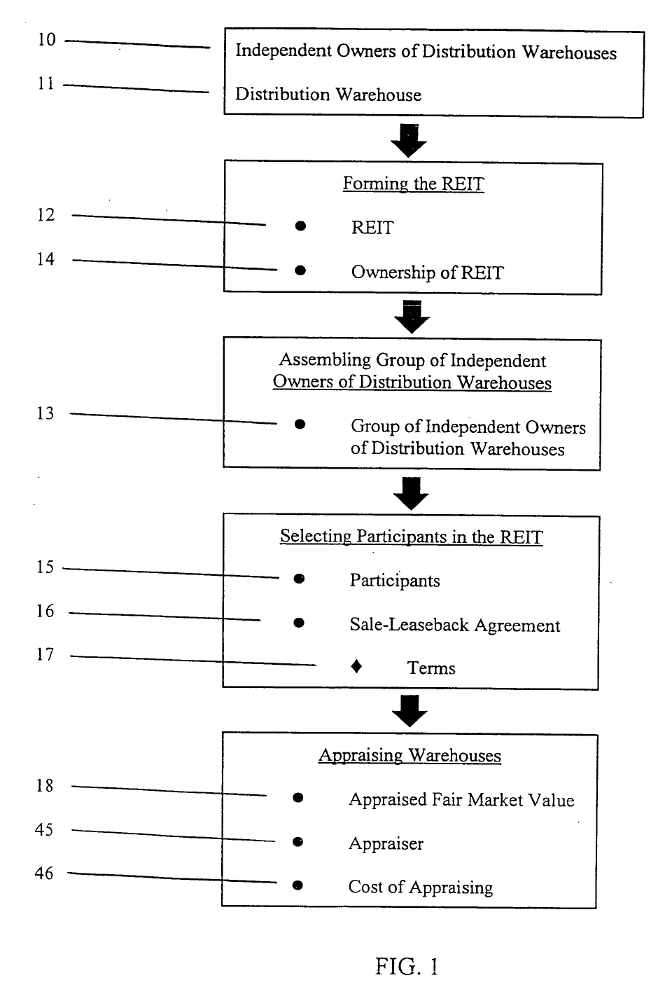

With reference to the figures where like elements have been given like numerical designation to facilitate an understanding of the present invention, and particularly with reference to the embodiment of the method of the present invention illustrated in FIGS. 1 through 5, the method of the present invention involves consolidating independent owners 10 of distribution warehouses 11 into a Real Estate Investment Trust or REIT 12.

As shown in FIG. 1, REIT 12 is formed. REIT 12 may be formed by completing and filing all required paperwork in compliance with applicable law. The formation of REIT 12 would be well understood by one of ordinary skill in the art to which the invention pertains. REIT 12 may be formed by any person or entity desiring to form REIT 12. For example, REIT 12 may be formed by any person or entity wishing to be a participant 15 in REIT 12 or by any person or entity wishing to manage or control REIT 12, as for instance, manager 93.

FIG. 1 also shows owners 10 being assembled into group of independent owners 13 of distribution warehouses 11 who are willing to participate in REIT 12. Group of independent owners 13 may be assembled by any person or entity desiring to assemble group of independent owners 13. Preferably, group of independent owners 13 is assembled by any person or entity who formed REIT 12 or by any person or entity desiring to associate with, participate in, manage, or control REIT 12. For example, group of independent owners 13 may be assembled by any person or entity wishing to be a participant 15 in REIT 12 or by any person or entity wishing to manage or control REIT 12, as for instance, manager 93.

As illustrated in FIG. 1, participants 15 are selected to participate in REIT 12 from group of independent owners 13 of distribution warehouses 11. Any person or entity may select participants 15 to participate in REIT 12. Preferably, a person or entity having an interest in REIT 12 selects participants 15. Such persons may include one or more owners 10 who are part of group of independent owners 13 of distribution warehouses 11, an actual or potential participant 15, an actual or potential manager 93, and/or lender 27.

It is preferred that participants 15 are selected to participate in REIT 12 by having each owner 10 from group of independent owners 13 of distribution warehouses 11 provide a financial statement to the person(s) and/or entity(ies) selecting participants 15. More preferably, each owner 10 from group of independent owners 13 of distribution warehouses 11 provides a financial statement for each of the past five years preceding the current year.

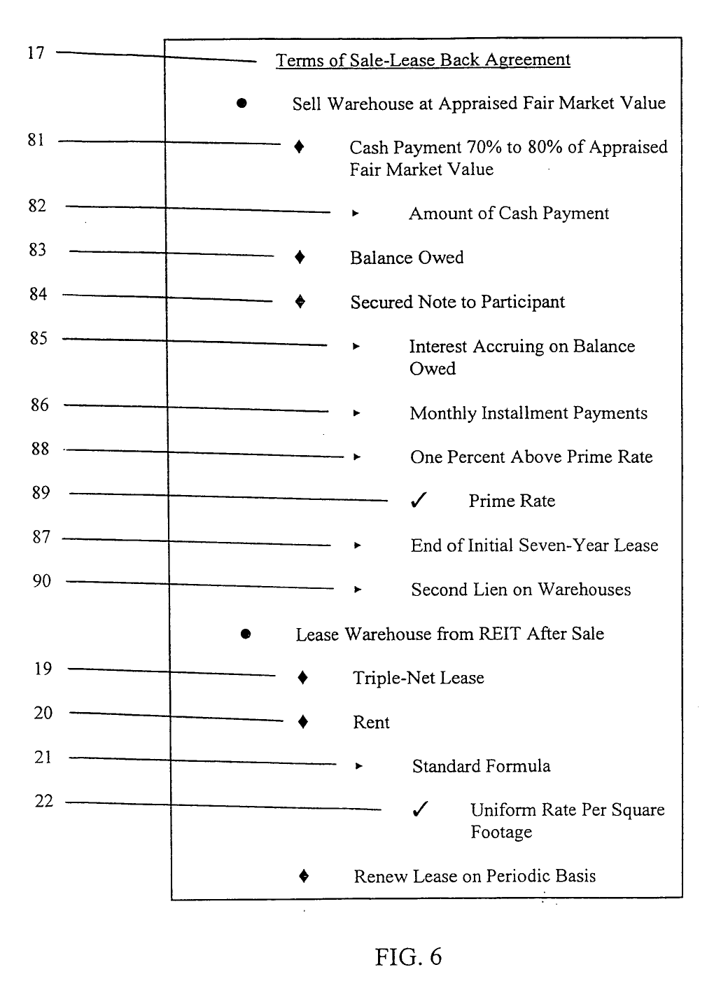

FIGS. 1 and 6 show that as part of or in connection with the selection of participants 15, each participant 15 preferably enters into sale-leaseback agreement 16 with REIT 12. Sale-leaseback agreement 16 may include terms 17. Terms 17 of sale-leaseback agreement 16 preferably obligate participant 15 to sell warehouse 11 owned by participant 15 to REIT 12 and for REIT 12 to purchase warehouse 11 from participant 15. Terms 17 of sale-leaseback agreement 16 may also provide that the sales price for warehouse 11 is set at appraised fair market value 18 of warehouse 11 owned by participant 15. Terms 17 of sale-leaseback agreement 16 may also obligate participant 15 to lease warehouse 11 from REIT 12 under lease agreement 24 that provides for triple-net lease 19 after warehouse 11 is sold to and purchased by REIT 12.

Terms 17 of sale-leaseback agreement 16 may also require participant 15 to pay rent 20 to REIT 12. Preferably, terms 17 of sale-leaseback agreement 16 provide that rent 20 is determined by standard formula 21 that charges uniform rate per square footage 22 for warehouse 11 so that participant 15 knows in advance what rent 20 participant 15 will be required to pay to REIT 12.

Terms 17 of sale-leaseback agreement 16 may also obligate participant 15 to renew lease agreement 24 on a periodic basis. Preferably, participant 15 is obligated to renew lease agreement 24 at least every seven years and more preferably, every seven years.

FIG. 6 illustrates that terms 17 of sale-leaseback agreement 16 may obligate REIT 12 to purchase warehouse 11 owned by participant 15. Preferably, terms 17 of sale-leaseback agreement 16 specify that REIT 12 will purchase warehouse 11 from participant 15 for fair market value 18 of warehouse 11. It is further preferred if terms 17 of sale-leaseback agreement 16 further specify that REIT 12 will pay participant 15 cash payment 81.

Cash payment 81 is preferably amount 82 which is 70%-80% of appraised fair market value 18 of warehouse 11 thereby leaving balance owed 83. Terms 17 of sale-leaseback agreement may require REIT 12 to issue secured note 84 payable to participant 15 for balance owed 83. It is preferred if secured note 84 provides that REIT 12 will pay interest 85 accruing on balance owed 83 to participant 15. Preferably, interest 85 is paid in monthly installment payments 86. More preferably, secured note 84 provides that REIT 12 will pay balance owed 83 in full to participant 15 at the time REIT 12 obtains new non-recourse mortgage loan 38, preferably at end 87 of initial seven-year lease.

With reference to FIG. 1, warehouse 11 owned by each participant 15 is appraised to determine appraised fair market value 18. Preferably, the appraisal is conducted by at least one appraiser 45. It is preferred if appraiser 45 is selected by lender 27 who issues non-recourse mortgage loan 26 to REIT 12. It is further preferred if appraiser 45 is an MAI appraiser. Participant 15 preferably pays for cost 46 of the appraisal of warehouse 11 owned by participant 15.

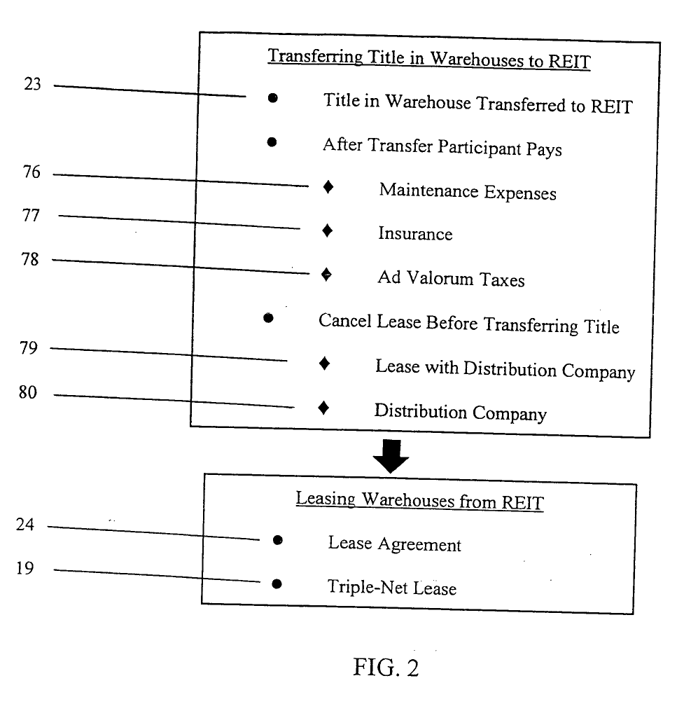

FIG. 2 reveals that title 23 of warehouse 11 owned by each participant 15 is transferred to REIT 12. Transfer of title 23 in warehouse 11 owned by each participant 15 may be accomplished when REIT 12 purchases warehouse 11 from participant 15 by paying participant 15 appraised fair market value 18 of warehouse 11. After transferring title 23 in warehouse 11, each participant 15 continues to pays maintenance expenses 76, insurance 77, and/or ad valorum taxes 78 accruing from warehouse 11 that participant 15 sold to REIT 12.

Again with reference to FIG. 2, if before transferring title 23 in warehouse 11 to REIT 12, participant 15 has entered into lease 79 for warehouse 11 with distribution company 80 controlled by participant 15, lease 79 is preferably cancelled before participant 15 transfers title 23 in warehouse 11 to REIT 12. Thus, title 23 in warehouse 11 is transferred to REIT 12 unencumbered by lease 79 so that REIT 12 and participant 15 are free to enter into triple-net lease 19 by signing and entering into lease agreement 16 for warehouse 11.

It is preferred if transfer of title 23 in warehouse 11 of each participant 15 to REIT 12 occurs in conjunction with or as part of the purchase by REIT 12 of warehouse 11 from each participant 15.

The purchase of warehouse 11 by REIT 12 from each participant 15 may be accomplished as part of sale-leaseback agreement 16 or may be accomplished by REIT 12 and each participant 15 entering into separate purchase or buy-sell agreements or comparable agreements. The required agreements to effect transfer of title 23 in each warehouse 11 to REIT 12 and the purchase of each warehouse 11 by REIT 12 would be understood by a skilled artisan to which the subject matter of the present invention pertains.

REIT 12 purchases warehouse 11 from each participant 15 by paying to participant 15 fair market value 18 of warehouse 11. Preferably, REIT 12 pays participant 15 cash payment 81 which may be amount 82 which is 70%-80% of appraised fair market value 18 of warehouse 11 thereby leaving balance owed 83. REIT 12 may issue secured note 84 payable to participant 15 for balance owed 83. It is preferred if secured note 84 provides that REIT 12 will pay interest 85 accruing on balance owed 83 to participant 15. Preferably, interest 85 is paid in monthly installment payments 86. More preferably, secured note 84 provides that REIT 12 will pay balance owed 83 in full to participant 15 at the time REIT 12 obtains new non-recourse mortgage loan 38 at end 87 of the initial seven-year lease.

The money received by each participant from REIT 12, as for example money from cash payment 81, monthly installment payments 86, and payment of balance owed 83, may be used by participant 15 as deemed necessary. For example, participant 15 could use the money to pay off debt or could invest in short-term municipal bonds or other investments that will produce income to participant 15.

Interest 85 in secured note 84 is preferably set at one-percent above 88 prime rate 89 that exists when REIT 12 issues secured note 84. Preferably, prime rate 89 is the prime rate published in the Wall Street Journal. It is also preferred if secured note 84 is secured by second lien 90 on warehouse 11 sold by participant 15 to REIT 12. Second lien 90 may be recorded in the appropriate depository or registry to comply with applicable recordation requirements.

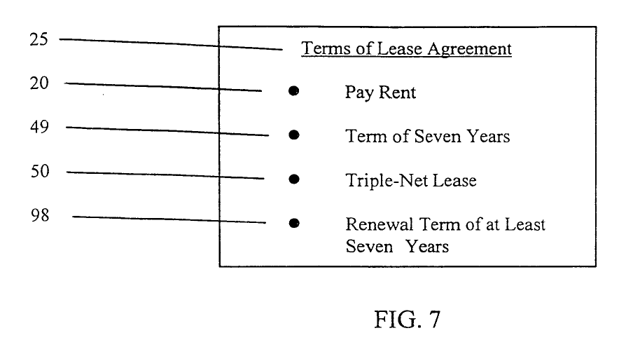

With reference to FIGS. 2 and 7, REIT 12 and each participant 15 enter into lease agreement 24 for warehouse 11 sold by participant 15 to REIT 12. It is preferred if lease agreement 24 has terms 25 obligating participant 15 to pay rent 20 to REIT 12. Lease agreement 24 is preferably for term 49 of at least seven years and more preferably seven years. Lease agreement 24 preferably is triple-net lease 50 so that rent 20 paid by all participants 15 to REIT 12 equals or is greater than scheduled debt service 51 on non-recourse mortgage loan 26 issued to REIT 12.

Sale-leaseback agreement 16 and/or lease agreement 24 may specify standard formula 21 that charges uniform rate per square footage 22 of warehouse 11 so that participant 15 knows before entering sale-lease agreement 16 and/or lease agreement 24 what specific annual rent 65 participant 15 will be required to pay to REIT 12 for warehouse 11.

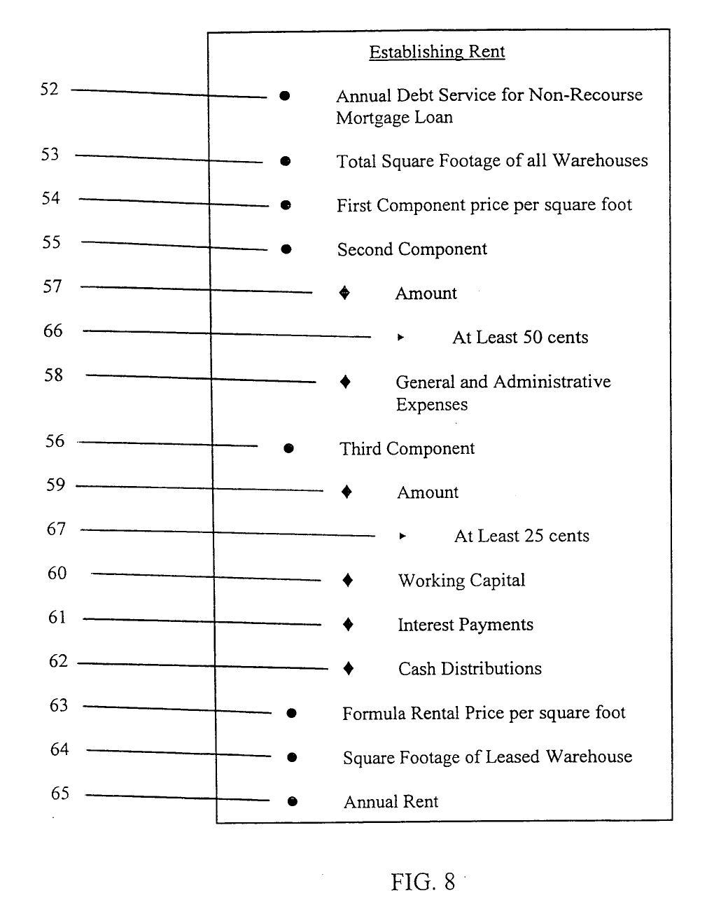

As shown in FIG. 8, rent 20 is established by determining annual debt service amount 52 for non-recourse mortgage loan 26 that issued or will issue to REIT 12. Total square footage 53 of all warehouses 11 leased or to be leased by REIT 12 is determined. Annual debt service amount 52 is divided by total square footage 53 to derive first component price per square foot 54. Second component 55 and third component 56 are then added to first component 54. Second component 55 is amount 57 which is dedicated for use by REIT 12 to pay for general and administrative expenses 58 of REIT 12. Third component 56 is amount 59 which is dedicated for use by REIT 12 as working capital 60 and to permit REIT 12 to make interest payments 61 and cash distributions 62 to participants 15.

The addition of second component 55 and third component 56 to first component 54 results in formula rental price per square foot 63. Formula rental price per square foot 63 is multiplied by square footage 64 of warehouse 11 leased or to be leased to participant 15 to derive annual rent 65 to be paid by participant 15 to REIT 12. It is preferred if second component 55 is at least 50 cents per square foot 66 and more preferably, 50 cents per square foot. It is also preferred if third component 56 is at least 25 cents per square foot 67 and more preferably 25 cents per square foot.

By way of example, if non-recourse mortgage loan 26 is 160 million dollars which is amortized over seven years at an interest rate of 5.5%, the annual payment of principal and interest, which is annual debt service 52, will be $27,588,000. Assuming there is 10 million total square footage 53 of warehouses 11, annual debt service 52 of $27,588,000 is divided by total square footage 53 of 10 million square feet to derive first component price per square foot 54 of $2.75 per square foot. Second component 55 of 50 cents per square foot (covering general and administrative expenses 58) and third component 56 of 25 cents per square foot (covering working capital 60, interest payments 61, and cash distributions 62) are added to first component price per square foot 54 of $2.75 per square foot to derive formula rental price per square foot 63 of $3.50 per square foot.

By determining annual rent 65 using formula rental price per square foot 63, a safeguard is implemented which protects participants 15 against REIT 12 arbitrarily setting annual rent 65. Also, the procedure prevents REIT 12 from paying out general and administrative expenses 58 that exceed that portion of annual rent 65 (first component 54 of 50 cents per square foot) collected by REIT 12, which is dedicated for use by REIT 12 for general and administrative expenses 58.

It is preferred if each sale-leaseback agreement 16 and lease agreement 24 are contemporaneously entered into by REIT 12 and participant 15.

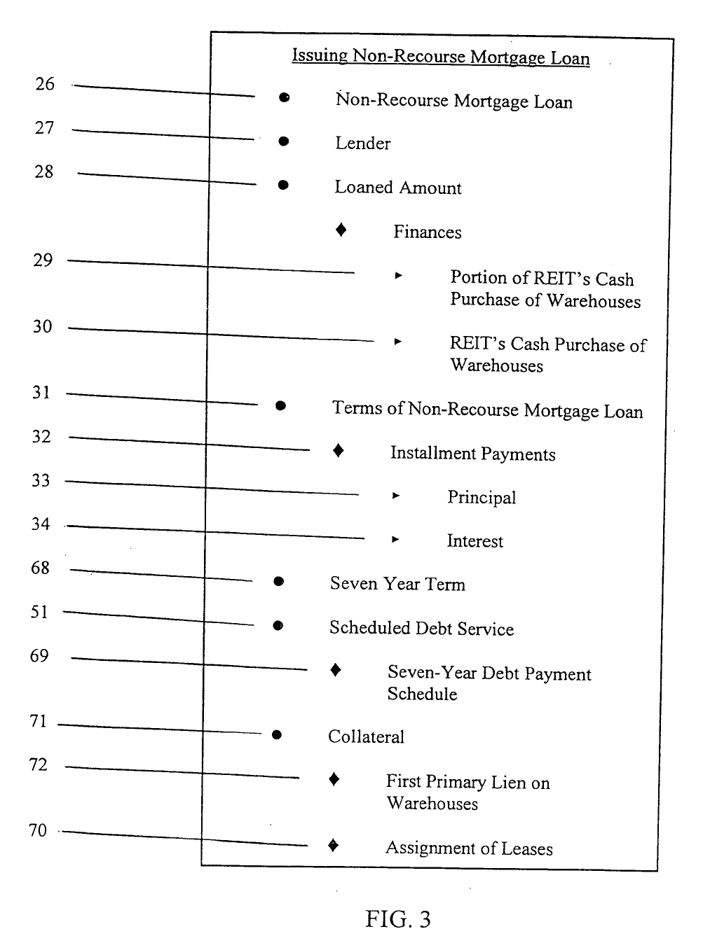

FIG. 3 illustrates that non-recourse mortgage loan 26 is issued to REIT 12. Preferably, non-recourse mortgage loan 26 is issued by lender 27. It is preferred if non-recourse mortgage loan 26 is issued for loaned amount 28 which is capable of financing at least portion 29 of cash purchase 30 made by REIT 12 for warehouses 11. Lender 27 is preferably a banking institution, as for example, a bank or savings and loan.

Non-recourse mortgage loan 26 may be issued under terms 31 obligating REIT 12 to make installment payments 32 of principal 33 and interest 34 to lender 27 on loaned amount 28. REIT 12 may use rent 20 paid by participants 15 to make installment payments 32 to lender 27. Preferably, non-recourse mortgage loan 26 has term 68 of at least seven years and more preferably seven years. It is also preferred if non-recourse mortgage loan 26 is serviced on at least seven-year debt payment schedule 69 and more preferably a seven-year debt payment schedule 69.

Lender 27 may require REIT 12 to pledge warehouses 11 and/or assignment 70 of lease agreements 24 as collateral 71 for non-recourse mortgage loan 26. Lender 27 will have first primary lien 72 on warehouses 11. Non-recourse mortgage loan 26 preferably finances cash payment 81 made by REIT 12 to participants 15 to purchase warehouses 11.

Non-recourse mortgage loan 26 and new non-recourse mortgage loan 38 (because they are non-recourse) mean that REIT 12 will not have to endorse or guarantee, either through the corporate entity or individually through participants 15, payment of non-recourse mortgage loan 26 and/or new non-recourse mortgage loan 38.

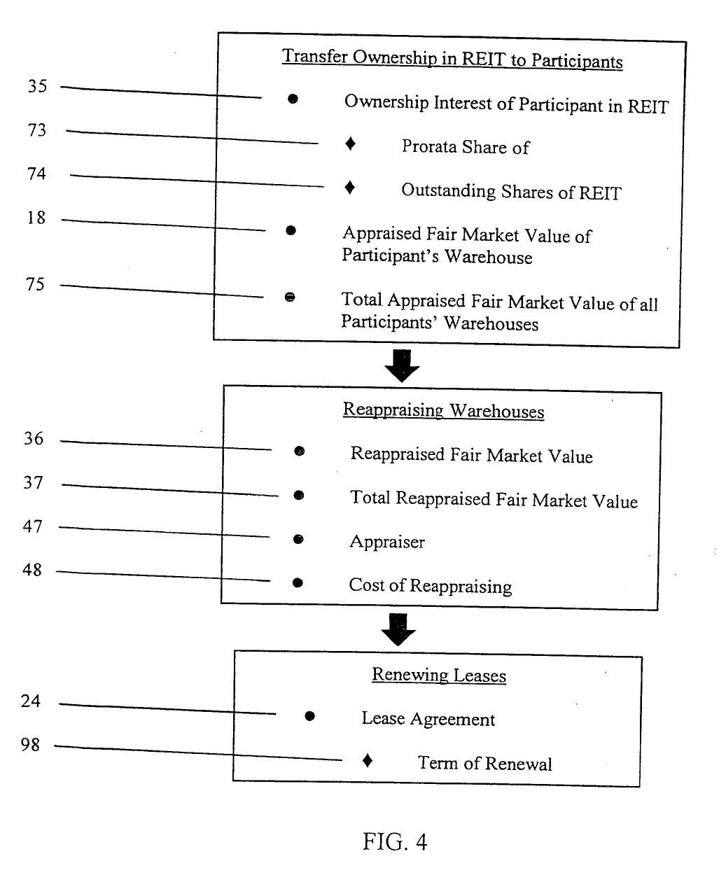

As shown in FIG. 4, ownership interest 35 in REIT 12 is transferred to each participant 15. Preferably, ownership interest 35 of each participant 15 in REIT 12 is prorata share 73 of outstanding shares 74 of REIT 12. Prorata share 73 of ownership interest 35 of participant 15 in REIT 12 is calculated by dividing appraised fair market value 18 of warehouse 11 sold or to be sold by participant 15 to REIT 12 by total appraised fair market value 75 of all warehouses 11 sold or to be sold by all participants to REIT 12.

As an example, if warehouse 11 sold or to be sold by participant 15 to REIT 12 has appraised fair market value 18 of $1 million and total appraised fair market value 75 of all warehouses 11 sold or to be sold by all participants to REIT 12 is $200 million, participant will receive a 0.5 or ½% ownership interest 35 in REIT 12.

As shown in FIG. 4, each warehouse 11 owned by REIT 12 may be reappraised to determine reappraised fair market value 36 thereof. Reappraised fair market value 36 of each warehouse 11 is used to calculate (by adding) total reappraised fair market value 37 of all warehouses 11 owned by REIT 12. Preferably, the reappraisal is conducted by at least one appraiser 47 (preferably an MAI appraiser) selected by lender 40 who issues new non-recourse mortgage loan 38 to REIT 12. It is preferred if REIT 12 pays for cost 48 of reappraising warehouses 11.

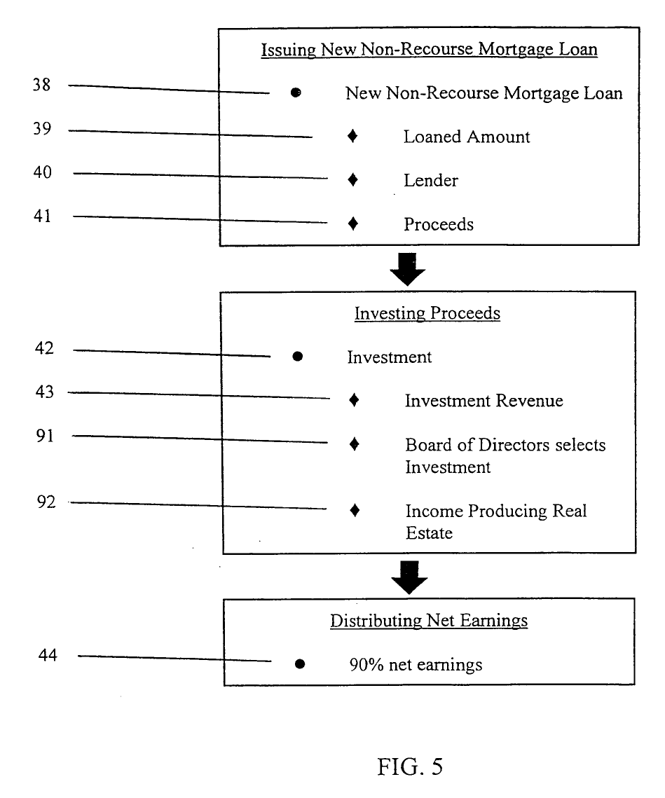

Again with reference to FIG. 4, each lease agreement 24 entered into between REIT 12 and participants 15 maybe renewed. Preferably, lease agreements 24 are renewed for term 98 of at least seven years and more preferably seven years. With reference to FIG. 5, new non-recourse mortgage loan 38 is issued to REIT 12 for loaned amount 39 that is 70%-80% of total reappraised fair market value 37 of all warehouses 11. Preferably, new non-recourse mortgage loan 38 is issued by lender 40. New non-recourse mortgage loan 38 provides proceeds 41 to REIT 12.

Lender 40 is preferably a banking institution, as for example, a bank or savings and loan. Lender 27 and lender 40 may be the same lending institution or different lending institutions. REIT 12 or preferably Board of Directors 91 of REIT 12 may select lender 27 and/or lender 40.

As referenced in FIG. 5, REIT 12 may invest proceeds 41 in at least one investment 42 capable of producing investment revenue 43. Preferably, Board of Directors 91 of REIT 12 selects investment 42. It is preferred if multiple investments 42 are made by REIT 12 using proceeds 41. It is also preferred if investment 42 includes income producing real estate 92. REIT 12 preferably distributes at least 90% of net earnings 44 from investment revenue 43 to participants 15.

It is preferred if the events of (1) reappraising each warehouse 11, (2) renewing each lease agreement 24, (3) issuing new non-recourse mortgage loan 38 to REIT 12, and (4) investing proceeds 41 from new non-recourse mortgage loan 38, occur or take place on a periodic basis, preferably at least every seven years, and more preferably every seven years.

Because REIT 12 and each participant 15 are lessor and lessee of warehouses 11, lease agreements 24 can be redrawn at any time and warehouses 11 reappraised and re-mortgaged. The ability to control lease agreements 24 and re-mortgage warehouses 11 on a periodic basis, or preferably every seven years, permits REIT 12 to “pump” out the equity of warehouses 11 preferably every seven years and invest proceeds 41 in carefully selected investments 42 which are preferably real estate investments. Investing proceeds 41 in investments 42 is accomplished by processes well understood by one of ordinary skill in the art to which the invention pertains. Such investment of proceeds 41 should be based on sound investment strategies that maximize the income earning potential of investments 42.

As an example, if REIT 12 starts with 10 million total square feet 53 of warehouses 11, total appraised fair market value 75 of warehouses 11 will be about $200 million ($20 per square foot). The “pump” out every seven years will be about 62% to 70% multiplied by $200 million, which equals about $100 million to be invested in investments 42. Over a period of 50 to 100 years, REIT 12 will likely assume a size that will make REIT 12 one of the largest REITs of its kind. Moreover, there is never any leverage or borrowing on investments 42 made by REIT 12, although this is an option. Only warehouses 11 are remortgaged.

Investments 42 will likely increase in value thereby increasing the equity of REIT 12. Over time, REIT 12 will be more valuable to participants 15 than ownership of their respective distribution companies and/or warehouses 11. If distribution companies owned by or constituting participants 15 ever cease to exist, for whatever reason, participants 15 will still have their ownership interests 35 in REIT 12.

Again with reference to FIG. 5, net earnings 44 from investment revenue 43 generated from investments 42 will be distributed by REIT 12 to participants 15 each year, if net earnings 44 have been generated during the existing year. Applicable law requires REIT 12 to distribute at least 90% of net earnings 44 on an annual basis to qualify as a REIT and to avoid federal corporate income tax.

Net earnings 44 of REIT 12 will never be compromised by exorbitant overhead since the overhead of REIT 12 must be contained and encompassed with annual management fee 96 based on amount 97 which is derived using first component price per square foot 54, preferably in the amount of 50 cents per square foot. As stated above, first component price per square foot 54 is dedicated for general and administrative expenses 58 of REIT 12.

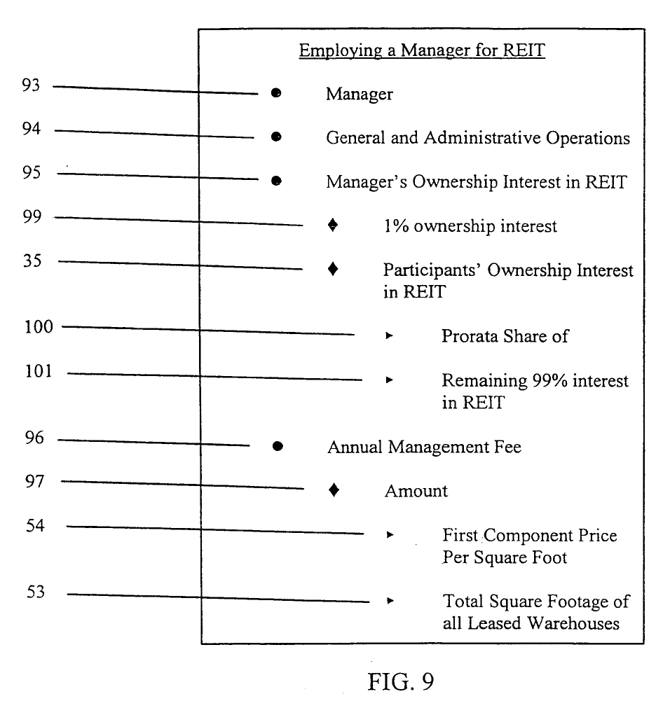

An alternative embodiment of the present invention is shown in FIG. 9. In this embodiment, manager 93 is employed by and for REIT 12. Manager 93 may be responsible for general and administrative operations 94 of REIT 12. It is preferred if manager 93 acquires ownership interest 95 in REIT 12.

REIT 12 may pay manager 93 annual management fee 96. It is preferred if annual management fee 96 is amount 97 that is computed by multiplying first component price per square foot 54 by total square footage 53 of all warehouses 11.

It is preferred if manager 93 has one-percent ownership interest 99 in REIT 12. In this case, each ownership interest 35 of participant 15 in REIT 12 is prorata share 100 of remaining 99% interest 101 of REIT 12. Prorata share 100 of ownership interest 99 of participants 15 in REIT 12 is calculated by dividing appraised fair market value 18 of warehouse 11 sold or to be sold by participant 15 to REIT 12 by total appraised fair market value 75 of all warehouses 11 sold or to be sold by all participants to REIT 12.

Manager 93 of REIT 12 preferably attempts to secure for participants 15 and for REIT 12 all economies of scale that can be negotiated on the strength of the consolidation as provided by REIT 12. Such economies of scale may be negotiated in areas of truck purchases, truck rentals, freight, warehouse equipment, purchases and rental, warehouse security systems, technological systems for warehouse operations, insurance on warehouses 11, taxes on warehouse property and the like.

Manager 93 of REIT 12 may also act as a buying group for participants 15 without charging participants 15 for the service. This will permit rebates from purchases from preferred vendors within a buying group to be passed through to participants 15 at 100 cents on the dollar thus saving participants 15 the amount of rebate which is customarily held back by buying groups to fund the buying groups' operation. For example, most buying groups retain anywhere from 10 cents to 20 cents on the dollar of every rebate paid by the preferred vendors. With REIT 12 handling the same chores as a buying group, collecting and dispersing rebates to participants 15, rebate funds could go entirely to participants 15.

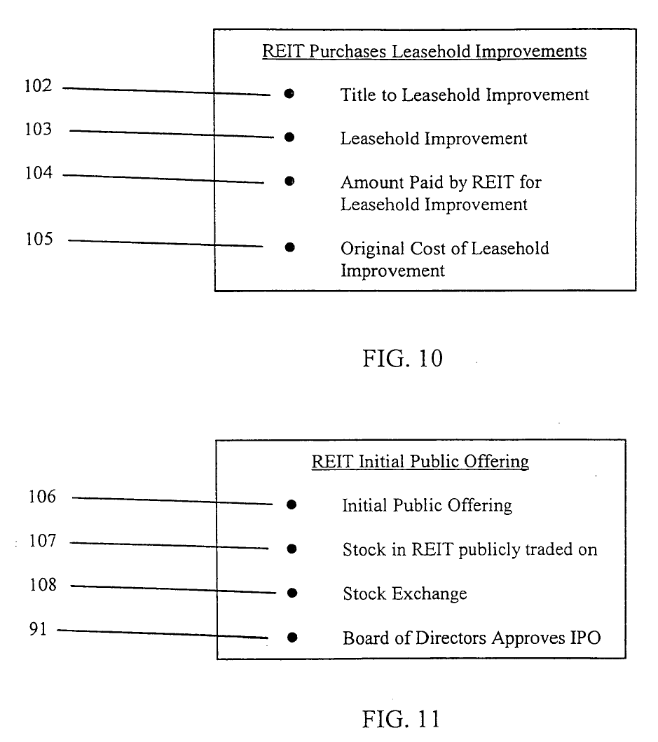

FIG. 10 shows another alternative embodiment of the present invention in which REIT 12 purchases and obtains title 102 to leasehold improvement 103 made by participant 15 in warehouse 11 during term 49 of lease agreement 24 or renewal term 98 thereof. It is preferred if REIT 12 pays participant 15 an amount 104 that is original cost 105 of participant 15 for leasehold improvement 103. It is also preferred if purchase of leasehold improvement 103 by REIT 12 is accomplished at the time lease agreement 24 is renewed.

FIG. 11 also shows an alternative embodiment of the present invention wherein stock 102 in REIT 12 is subject to initial public offering 106. It is preferred that stock 107 of REIT 12 is publicly offered on a recognized stock exchange 108. It is also preferred if initial public offering 106 is approved by Board of Directors 91 of REIT 12.

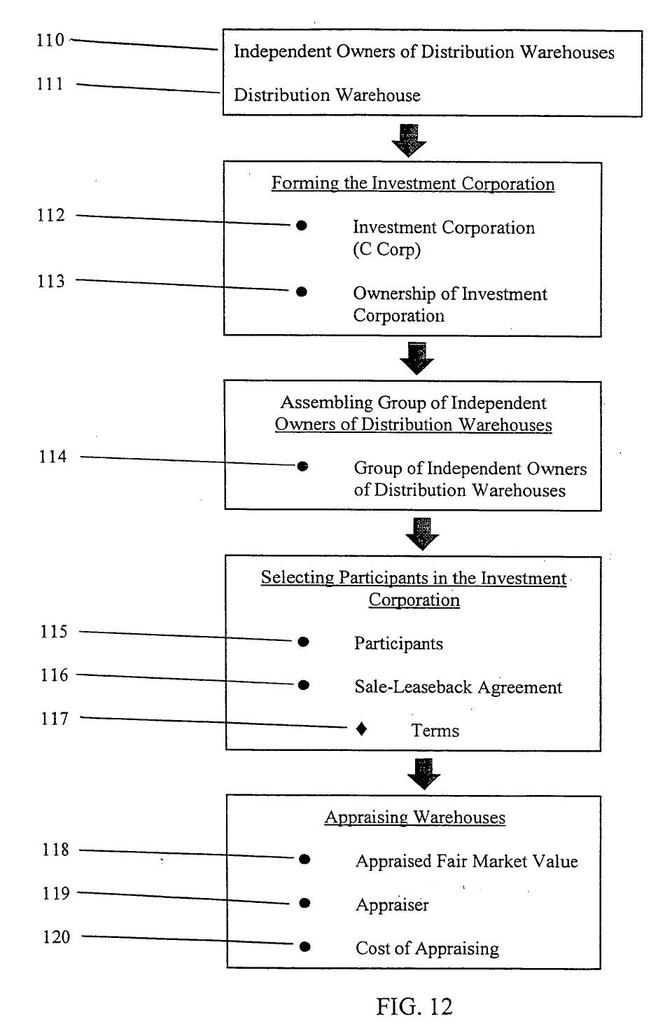

An alternative embodiment of the method of the present invention is illustrated in FIGS. 12 through 21. The alternative embodiment of the method of the present invention involves consolidating independent owners 110 of distribution warehouses 111 into an investment corporation 112, which preferably is a sub-chapter C corporation (hereinafter sometimes referred to as “Corporation”).

As shown in FIG. 12, Corporation 112 is formed. Corporation 112 may be formed by completing and filing all required paperwork in compliance with applicable law. The formation of Corporation 112 would be well understood by one of ordinary skill in the art to which the invention pertains. Corporation 112 may be formed by any person or entity desiring to form Corporation 112. For example, Corporation 112 may be formed by any person or entity wishing to be a participant 115 in Corporation 112 or by any person or entity wishing to manage or control Corporation 112, as for instance, management company 160.

FIG. 12 also shows owners 110 being assembled into group of independent owners 114 of distribution warehouses 111 who are willing to participate in Corporation 112. Group of independent owners 114 may be assembled by any person or entity desiring to assemble group of independent owners 114. Preferably, group of independent owners 114 is assembled by any person or entity which formed Corporation 112 or by any person or entity desiring to associate with, participate in, manage, or control Corporation 112. For example, group of independent owners 114 may be assembled by any person or entity wishing to be a participant 115 in Corporation 112 or by any person or entity wishing to manage or control Corporation 112, as for instance, management company 160.

As illustrated in FIG. 12, participants 115 are selected to participate in Corporation 112 from group of independent owners 114 of distribution warehouses 111. Any person or entity may select participants 115 to participate in Corporation 112. Preferably, a person or entity having an interest in Corporation 112 selects participants 115. Such persons may include one or more owners 110 who are part of group of independent owners 114 of distribution warehouses 111, an actual or potential participant 115, an actual or potential management company 160, and/or lender 130.

It is preferred that participants 115 are selected to participate in Corporation 112 by having each owner 110 from group of independent owners 114 of distribution warehouses 111 provide a financial statement to the person(s) and/or entity(ies) selecting participants 115. More preferably, each owner 110 from group of independent owners 114 of distribution warehouses 111 provides a financial statement for each of the past five years preceding the current year.

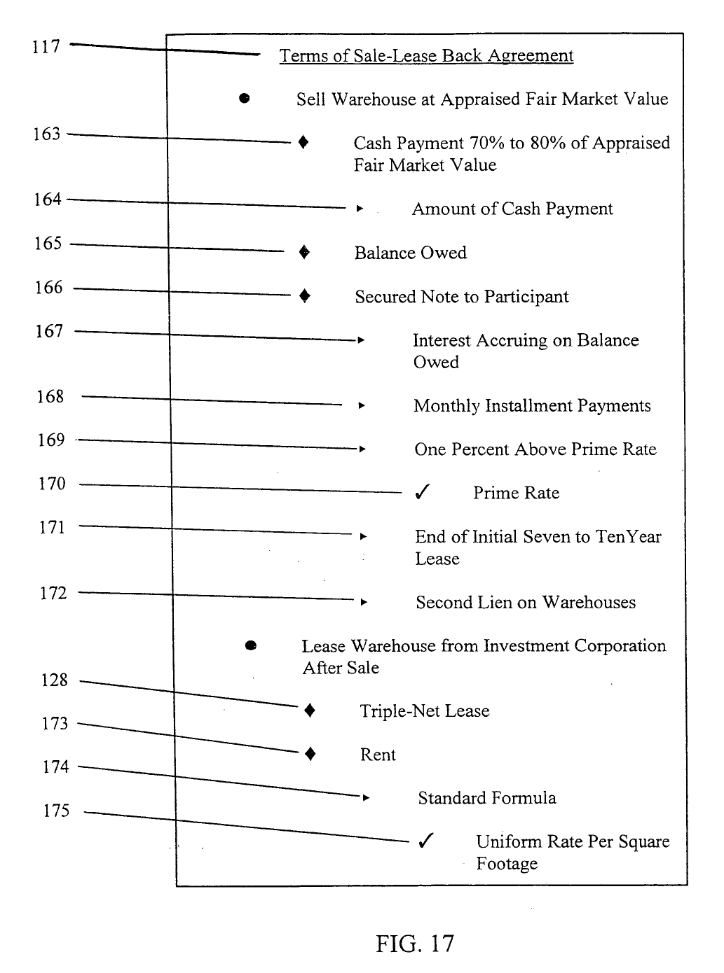

FIGS. 12 and 17 show that as part of or in connection with the selection of participants 115, each participant 115 preferably enters into sale-leaseback agreement 116 with Corporation 112. Sale-leaseback agreement 116 may include terms 117.

Terms 117 of sale-leaseback agreement 116 preferably obligate participant 115 to sell warehouse 111 owned by participant 115 to Corporation 112 and for Corporation 112 to purchase warehouse 111 from participant 115. Terms 117 of sale-leaseback agreement 116 may also provide that the sales price for warehouse 111 is set at appraised fair market value 118 of warehouse 111 owned by participant 115. Terms 117 of sale-leaseback agreement 116 may also obligate participant 115 to lease warehouse 111 from Corporation 112 under lease agreement 127 that provides for triple-net lease 128 after warehouse 111 is sold to and purchased by Corporation 112.

Terms 117 of sale-leaseback agreement 116 may also require participant 115 to pay rent 173 to Corporation 112. Preferably, terms 117 of sale-leaseback agreement 116 provide that rent 173 is determined by standard formula 174 that charges uniform rate per square footage 175 for warehouse 111 so that participant 115 knows in advance what rent 173 participant 115 will be required to pay to Corporation 112.

Terms 117 of sale-leaseback agreement 116 may also obligate participant 115 to renew lease agreement 127 on a periodic basis. Preferably, participant 115 is obligated to renew lease agreement 127 at least every seven to ten years and more preferably, every seven or ten years.

FIG. 17 illustrates that terms 117 of sale-leaseback agreement 116 may obligate Corporation 112 to purchase warehouse 111 owned by participant 115. Preferably, terms 117 of sale-leaseback agreement 116 specify that Corporation 112 will purchase warehouse 111 from participant 115 for fair market value 118 of warehouse 111. It is further preferred if terms 117 of sale-leaseback agreement 116 further specify that Corporation 112 will pay participant 115 cash payment 163.

Cash payment 163 is preferably amount 164 which is 70%-80% of appraised fair market value 118 of warehouse 111 thereby leaving balance owed 165. Terms 117 of sale-leaseback agreement may require Corporation 112 to issue secured note 166 payable to participant 115 for balance owed 165. It is preferred if secured note 166 provides that Corporation 112 will pay interest 167 accruing on balance owed 165 to participant 115. Preferably, interest 167 is paid in monthly installment payments 168. More preferably, secured note 166 provides that Corporation 112 will pay balance owed 165 in full to participant 115 at the time Corporation 112 obtains new non-recourse mortgage loan 154, preferably at end 171 of initial seven-year to ten-year lease.

With reference to FIG. 12, warehouse 111 owned by each participant 115 is appraised to determine appraised fair market value 118. Preferably, the appraisal is conducted by at least one appraiser 119. It is preferred if appraiser 119 is selected by lender 130 who issues non-recourse mortgage loan 129 to Corporation 112. It is further preferred if appraiser 119 is an MAI appraiser. Participant 115 preferably pays for cost 120 of the appraisal of warehouse 111 owned by participant 115.

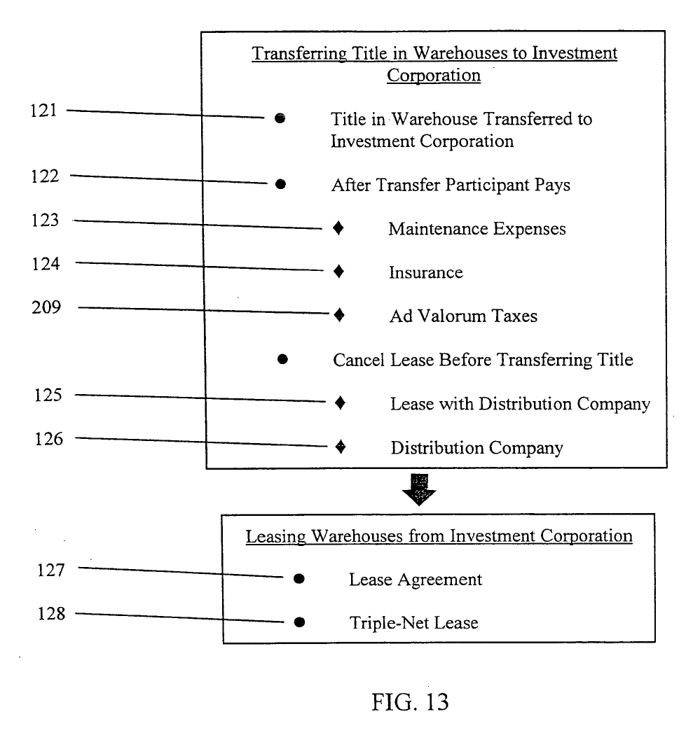

FIG. 13 reveals that title 121 of warehouse 111 owned by each participant 115 is transferred to Corporation 112. Transfer of title 121 in warehouse 111 owned by each participant 115 may be accomplished when Corporation 112 purchases warehouse 111 from participant 115 by paying participant 115 appraised fair market value 118 of warehouse 111. After transferring title 121 in warehouse 111, each participant 115 continues to pays maintenance expenses 123, insurance 124, and/or ad valorum taxes 209 accruing from warehouse 111 that participant 115 sold to Corporation 112.

Again with reference to FIG. 13, if before transferring title 121 in warehouse 111 to Corporation 112, participant 115 has entered into lease 125 for warehouse 111 with distribution company 126 controlled by participant 115, lease 125 is preferably cancelled before participant 115 transfers title 121 in warehouse 111 to Corporation 112. Thus, title 121 in warehouse 111 is transferred to Corporation 112 unencumbered by lease 125 so that Corporation 112 and participant 115 are free to enter into triple-net lease 128 by signing and entering into lease agreement 116 for warehouse 111.

It is preferred if transfer of title 121 in warehouse 111 of each participant 115 to Corporation 112 occurs in conjunction with or as part of the purchase by Corporation 112 of warehouse 111 from each participant 115.

The purchase of warehouse 111 by Corporation 112 from each participant 115 may be accomplished as part of sale-leaseback agreement 116 or may be accomplished by Corporation 112 and each participant 115 entering into separate purchase or buy-sell agreements or comparable agreements. The required agreements to effect transfer of title 121 in each warehouse 111 to Corporation 112 and the purchase of each warehouse 111 by Corporation 112 would be understood by a skilled artisan to which the subject matter of the present invention pertains.

Corporation 112 purchases warehouse 111 from each participant 115 by paying to participant 115 fair market value 118 of warehouse 111. Preferably, Corporation 112 pays participant 115 cash payment 163 which may be amount 164 which is 70%-80% of appraised fair market value 118 of warehouse 111 thereby leaving balance owed 165. Corporation 112 may issue secured note 166 payable to participant 115 for balance owed 165. It is preferred if secured note 166 provides that Corporation 112 will pay interest 167 accruing on balance owed 165 to participant 115. Preferably, interest 167 is paid in monthly installment payments 168. More preferably, secured note 166 provides that Corporation 112 will pay balance owed 165 in full to participant 115 at the time Corporation 112 obtains new non-recourse mortgage loan 154 at end 171 of the initial seven-year to ten-year lease.

The money received by each participant from Corporation 112, as for example money from cash payment 164, monthly installment payments 168, and payment of balance owed 165, may be used by participant 115 as deemed necessary. For example, participant 115 could use the money to pay off debt or could invest in short-term municipal bonds or other investments that will produce income to participant 115.

Interest 167 in secured note 166 is preferably set at one-percent above 169 prime rate 170 that exists when Corporation 112 issues secured note 166. Preferably, prime rate 170 is the prime rate published in the Wall Street Journal. It is also preferred if secured note 166 is secured by second lien 172 on warehouse 111 sold by participant 115 to Corporation 112. Second lien 172 may be recorded in the appropriate depository or registry to comply with applicable recordation requirements.

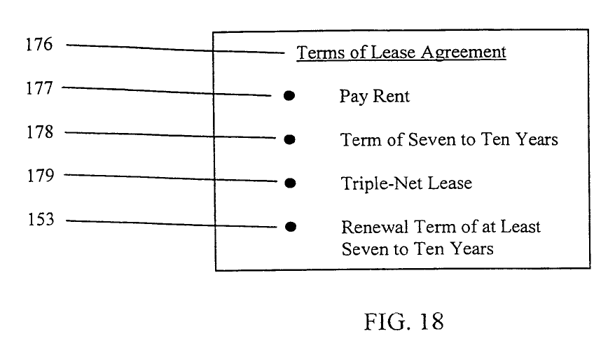

With reference to FIGS. 13 and 18, Corporation 112 and each participant 115 enter into lease agreement 127 for warehouse 111 sold by participant 115 to Corporation 112. It is preferred if lease agreement 127 has terms 176 obligating participant 115 to pay rent 177 to Corporation 112. Lease agreement 127 is preferably for term 178 of at least seven to ten years and more preferably seven or ten years. Lease agreement 127 preferably is triple-net lease 179 so that rent 177 paid by all participants 115 to Corporation 112 equals or is greater than scheduled debt service 139 on non-recourse mortgage loan 129 issued to Corporation 112.

Sale-leaseback agreement 116 and/or lease agreement 127 may specify standard formula 174 that charges uniform rate per square footage 175 of warehouse 111 so that participant 115 knows before entering sale-lease agreement 116 and/or lease agreement 127 what specific annual rent 195 participant 115 will be required to pay to Corporation 112 for warehouse 111.

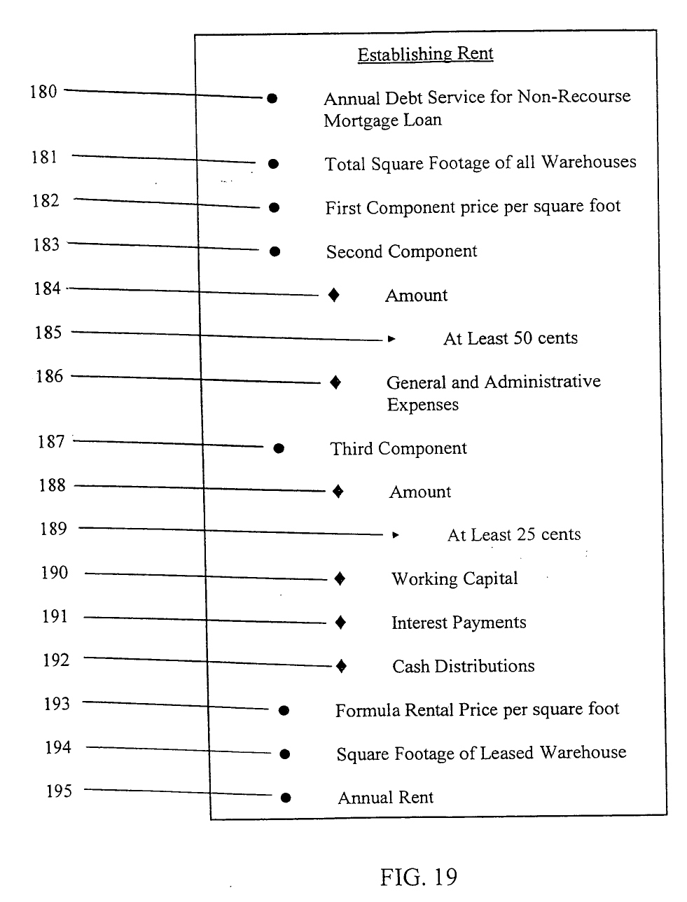

As shown in FIG. 19, rent 195 is established by determining annual debt service amount 180 for non-recourse mortgage loan 129 that issued or will issue to Corporation 112. Total square footage 181 of all warehouses 111 leased or to be leased by Corporation 112 is determined. Annual debt service amount 180 is divided by total square footage 181 to derive first component price per square foot 182. Second component 183 and third component 187 are then added to first component 182. Second component 183 is amount 184 which is dedicated for use by corporation 112 to pay for general and administrative expenses 186 of Corporation 112. Third component 187 is amount 188 which is dedicated for use by Corporation 112 as working capital 190 and to permit Corporation 112 to make interest payments 191 and cash distributions 192 to participants 115.

The addition of second component 183 and third component 187 to first component 182 results in formula rental price per square foot 193. Formula rental price per square foot 193 is multiplied by square footage 194 of warehouse 111 leased or to be leased to participant 115 to derive annual rent 195 to be paid by participant 115 to Corporation 112. It is preferred if second component 183 is at least 50 cents per square foot 185 and more preferably, 50 cents per square foot. It is also preferred if third component 187 is at least 25 cents per square foot 189 and more preferably 25 cents per square foot.

By determining annual rent 195 using formula rental price per square foot 193, a safeguard is implemented which protects participants 115 against Corporation 112 arbitrarily setting annual rent 195. Also, the procedure prevents Corporation 112 from paying out general and administrative expenses 186 that exceed that portion of annual rent 195 (first component 182 of 50 cents per square foot) collected by Corporation 112, which is dedicated for use by Corporation 112 for general and administrative expenses 186.

It is preferred if each sale-leaseback agreement 116 and lease agreement 127 are contemporaneously entered into by Corporation 112 and participant 115.

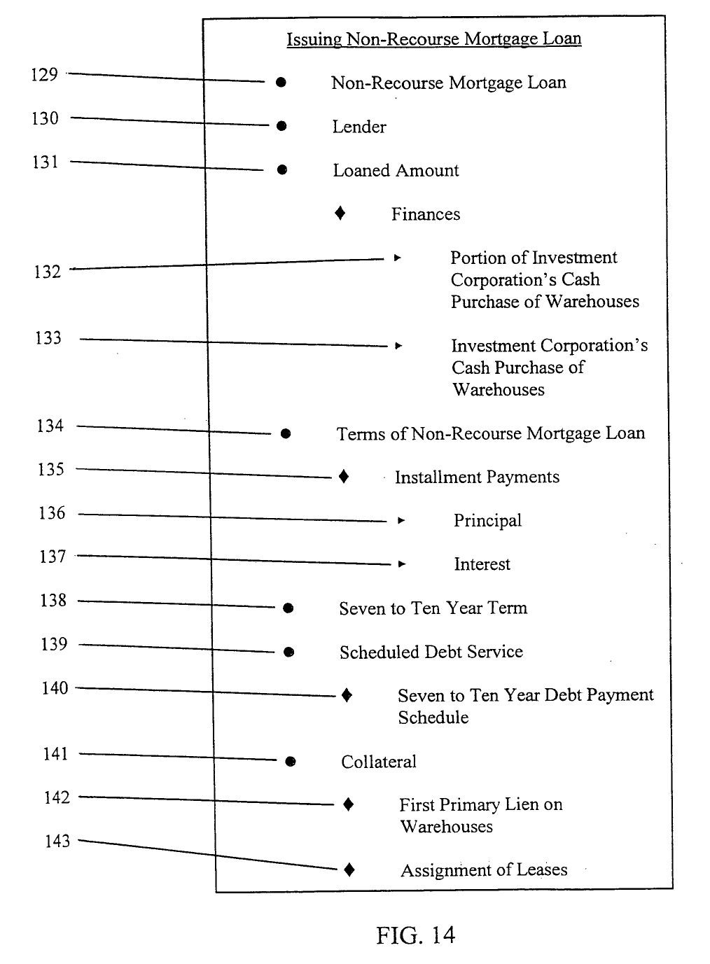

FIG. 14 illustrates that non-recourse mortgage loan 129 is issued to Corporation 112. Preferably, non-recourse mortgage loan 129 is issued by lender 130. It is preferred if non-recourse mortgage loan 129 is issued for loaned amount 131 which is capable of financing at least portion 132 of cash purchase 133 made by Corporation 112 for warehouses 111. Lender 130 is preferably a banking institution, as for example, a bank or savings and loan.

Non-recourse mortgage loan 129 may be issued under terms 134 obligating Corporation 112 to make installment payments 135 of principal 136 and interest 137 to lender 130 on loaned amount 131. Corporation 112 may use rent 173 paid by participants 115 to make installment payments 135 to lender 130. Preferably, non-recourse mortgage loan 129 has term 138 of at least seven to ten years and more preferably seven or ten years. It is also preferred if non-recourse mortgage loan 129 is serviced on at least seven-year to ten-year debt payment schedule 140 and more preferably a seven-year or ten-year debt payment schedule 140.

Lender 130 may require Corporation 112 to pledge warehouses 111 and/or assignment 143 of lease agreements 127 as collateral 141 for non-recourse mortgage loan 129. Lender 130 will have first primary lien 142 on warehouses 111. Non-recourse mortgage loan 129 preferably finances cash payment 164 made by Corporation 112 to participants 115 to purchase warehouses 111.

Non-recourse mortgage loan 129 and new non-recourse mortgage loan 154 (because they are non-recourse) mean that Corporation 112 will not have to endorse or guarantee, either through the corporate entity or individually through participants 115, payment of non-recourse mortgage loan 129 and/or new non-recourse mortgage loan 154.

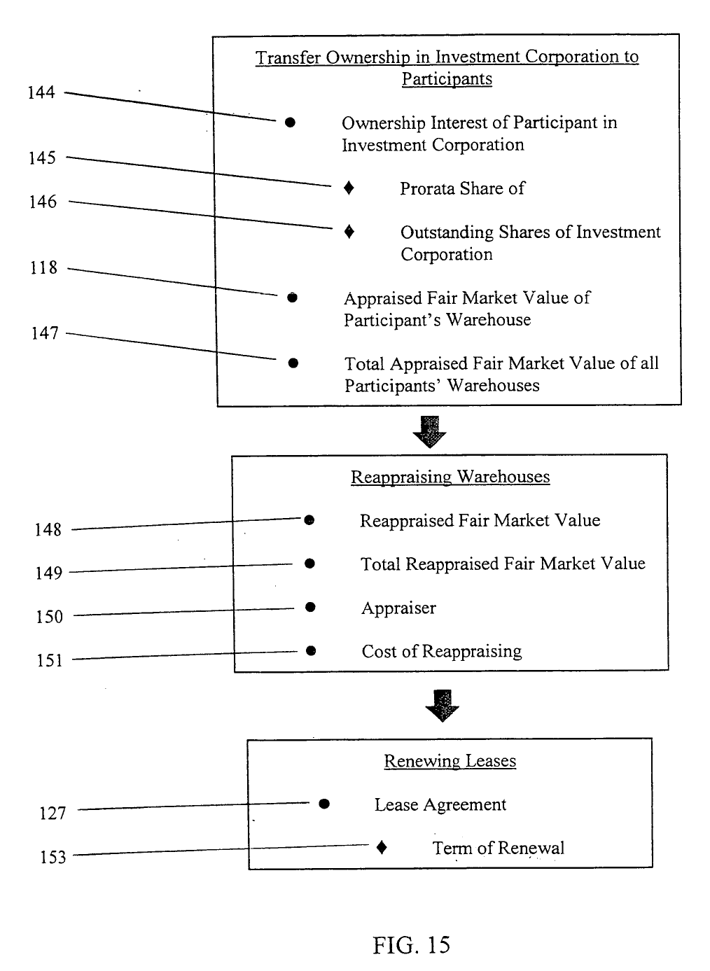

As shown in FIG. 15, ownership interest 144 in Corporation 112 is transferred to each participant 115. Preferably, ownership interest 144 of each participant 115 in Corporation 112 is prorata share 145 of outstanding shares 146 of Corporation 112. Prorata share 145 of ownership interest 144 of participant 115 in Corporation 112 is calculated by dividing appraised fair market value 118 of warehouse 111 sold or to be sold by participant 115 to Corporation 112 by total appraised fair market value 147 of all warehouses 111 sold or to be sold by all participants to Corporation 112.

As further shown in FIG. 15, each warehouse 111 owned by Corporation 112 may be reappraised to determine reappraised fair market value 148 thereof. Reappraised fair market value 148 of each warehouse 111 is used to calculate (by adding) total reappraised fair market value 149 of all warehouses 111 owned by Corporation 112. Preferably, the reappraisal is conducted by at least one appraiser 150 (preferably an MAI appraiser) selected by lender 156 who issues new non-recourse mortgage loan 154 to Corporation 112. It is preferred if Corporation 112 pays for cost 151 of reappraising warehouses 111.

Again with reference to FIG. 15, each lease agreement 127 entered into between Corporation 112 and participants 115 may be renewed. Preferably, lease agreements 127 are renewed for term 153 of at least seven to ten years and more preferably seven or ten years.

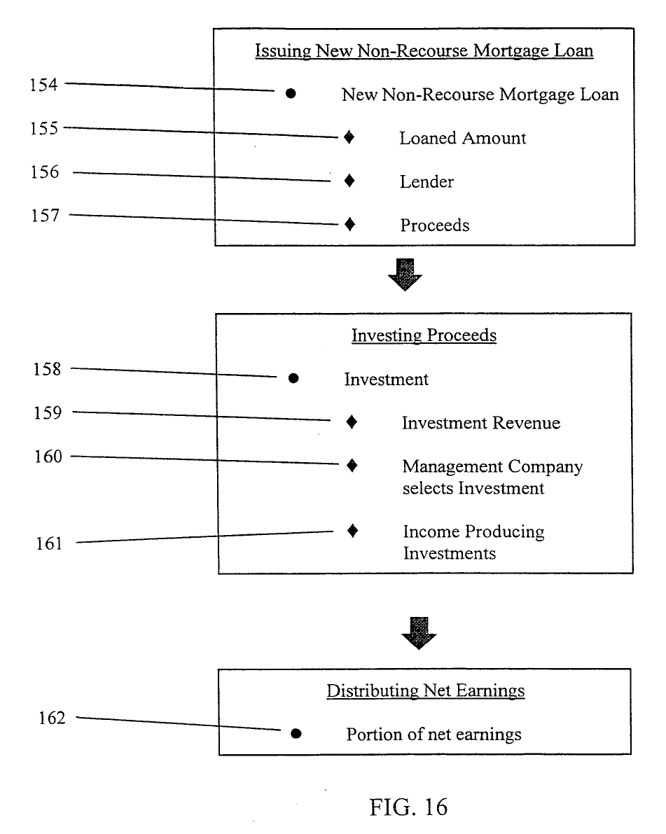

With reference to FIG. 16, new non-recourse mortgage loan 154 is issued to Corporation 112 for loaned amount 155 that is 70%-80% of total reappraised fair market value 149 of all warehouses 111. Preferably, new non-recourse mortgage loan 154 is issued by lender 156. New non-recourse mortgage loan 154 provides proceeds 157 to Corporation 112.

Lender 156 is preferably a banking institution, as for example, a bank or savings and loan. Lender 130 and lender 156 may be the same lending institution or different lending institutions. Corporation 112 (through its Board of Directors) or preferably management company 160 may select lender 130 and/or lender 156.

As referenced in FIG. 16, Corporation 112 may invest proceeds 157 in at least one investment 158 capable of producing investment revenue 159. Preferably, management company 160 selects investment 158 for Corporation 112. It is preferred if multiple investments 158 are made by Corporation 112 using proceeds 157. It is also preferred if investment 158 includes income producing investments 161 such as real estate. Corporation 112 preferably distributes at least a portion of net earnings 162 from investment revenue 159 to participants 115 as divided payments.

It is preferred if the events of (1) reappraising each warehouse 111, (2) renewing each lease agreement 127, (3) issuing new non-recourse mortgage loan 154 to Corporation 112, and (4) investing proceeds 157 from new non-recourse mortgage loan 154, occur or take place on a periodic basis, preferably at least every seven to ten years, and more preferably every seven or ten years.

Because Corporation 112 and each participant 115 are lessor and lessee of warehouses 111, lease agreements 127 can be redrawn at any time and warehouses 111 reappraised and re-mortgaged. The ability to control lease agreements 127 and re-mortgage warehouses 111 on a periodic basis, or preferably every seven to ten years, permits Corporation 112 to “pump” out the equity of warehouses 111 preferably every seven to ten years and invest proceeds 157 in cheerfully selected investments 158 which may be real estate investments or other investments. Investing proceeds 157 in investments 158 is accomplished by processes well understood by one of ordinary skill in the art to which the invention pertains. Such investment of proceeds 157 should be based on sound investment strategies that maximize the income earning potential of investments 158.

Again with reference to FIG. 16, portion of net earnings 162 from investment revenue 159 generated from investments 158 may be distributed by Corporation 112 to participants as a dividend payment on an annual basis if net earnings 162 have been generated during the existing year.

Net earnings 162 of Corporation 112 will never be compromised by exorbitant overhead since the overhead of Corporation 112 must be contained and encompassed with annual management fee 203 based on amount 204 which is derived using first component price per square foot 182, preferably in the amount of 50 cents per square foot. As stated above, first component price per square foot 182 is dedicated for general and administrative expenses 186 of Corporation 112.

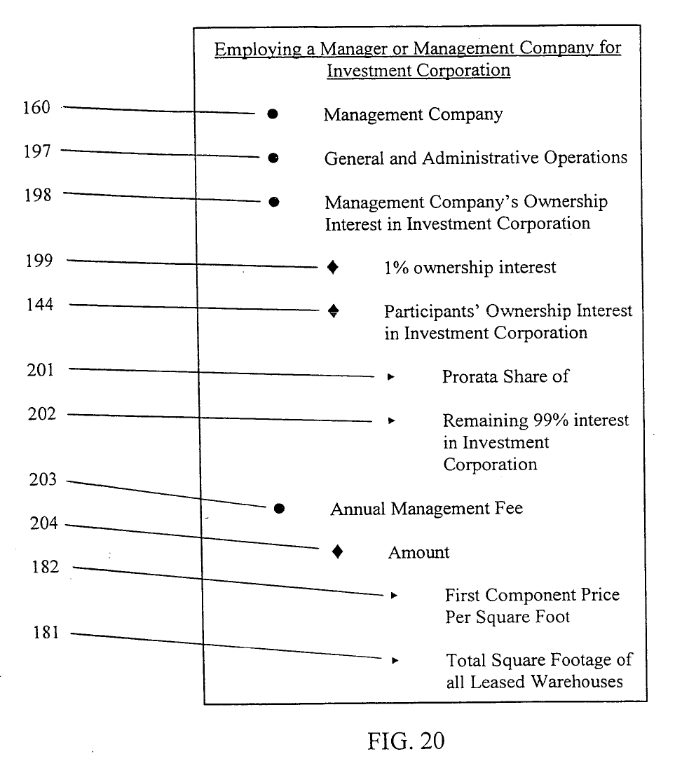

FIG. 20 shows that management company 160 may be employed by and for Corporation 112. Management company 160 may be responsible for general and administrative operations 197 of Corporation 112. It is preferred if management company 160 acquires ownership interest 198 in Corporation 112.

Corporation 112 may pay management company 160 annual management fee 203. It is preferred if annual management fee 203 is amount 204 that is computed by multiplying first component price per square foot 182 by total square footage 181 of all warehouses 111.

It is preferred if management company 160 has one-percent ownership interest 199 in Corporation 112. In this case, each ownership interest 144 of participant 115 in Corporation 112 is prorata share 201 of remaining 99% interest 202 of Corporation 112. Prorata share 201 of ownership interest 144 of participants 115 in Corporation 112 is calculated by dividing appraised fair market value 118 of warehouse 111 sold or to be sold by participant 115 to Corporation 112 by total appraised fair market value 147 of all warehouses 111 sold or to be sold by all participants 115 to Corporation 112.

Management company 160 of Corporation 112 preferably attempts to secure for participants 115 and for Corporation 112 all economies of scale that can be negotiated on the strength of the consolidation as provided by Corporation 112. Such economies of scale may be negotiated in areas of truck purchases, truck rentals, freight, warehouse equipment, purchases and rental, warehouse security systems, technological systems for warehouse operations, insurance on warehouses 111, taxes on warehouse property and the like.

Management company 160 of Corporation 112 may also act as a buying group for participants 115 without charging participants 115 for the service. This will permit rebates from purchases from preferred vendors within a buying group to be passed through to participants 115 at 100 cents on the dollar thus saving participants 115 the amount of rebate which is customarily held back by buying groups to fund the buying groups'operation. For example, most buying groups retain anywhere from 10 cents to 20 cents on the dollar of every rebate paid by the preferred vendors. With Corporation 112 handling the same chores as a buying group, collecting and dispersing rebates to participants 115, rebate funds could go entirely to participants 115.

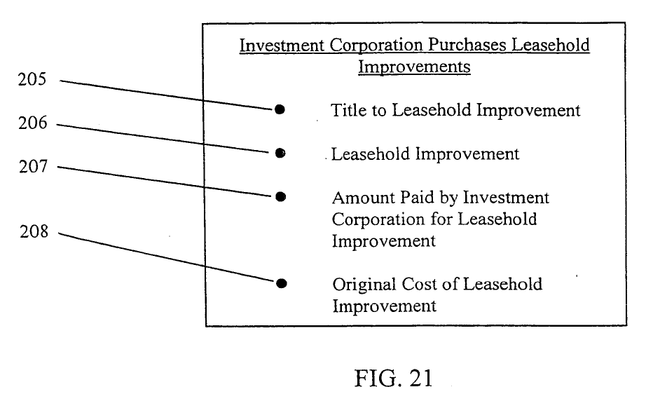

FIG. 21 shows another alternative embodiment of the present invention in which Corporation 112 purchases and obtains title 205 to leasehold improvement 206 made by participant 115 in warehouse 111 during term 49 of lease agreement 127 or renewal term 178 thereof. It is preferred if Corporation 112 pays participant 115 an amount 207 that is original cost 208 of participant 115 for leasehold improvement 206. It is also preferred if purchase of leasehold improvement 206 by Corporation 112 is accomplished at the time lease agreement 127 is renewed.

Unlike REIT 12, it is preferred that Corporation 112 be a privately held company.

In addition to the frequent re-mortgaging of warehouses 11 to provide investment capital for REIT 12 or of warehouses 111 to provide investment capital for Corporation 112, it is preferred if a long-term, e.g., 30-year amortization rate, is used in order to create a large differential between rental income of Corporation 112 and its debt service thus creating cash flow to make investments 158 in real estate income producing properties or other investment opportunities. As an example, say there is 10 million square feet of warehouses 111 appraised at $20 per square foot, with a rental of $4 per square foot. The rental income is $40 million per year and the debt service on $160 million in debt (80%) of appraised value at a 6% rate and a 30-year amortization is $9,529,000 per year. Therefore, the difference between rental income and debt service is about $31 million per year, which after deducting for overhead and taxes of Corporation 112 yields about $25 million per year for investment purposes.

The advantage of this procedure over the periodic re-mortgaging of warehouses 111 will be the fact that Corporation 112 can invest with proceeds on day one (or year one) rather than waiting seven or eight years to re-mortgage warehouses 111. Loan 129 would likely be a ten year term loan with a 30-year amortization, which means every ten years Corporation 112 re-mortgages warehouses 111 to provide additional capital for investment purposes.

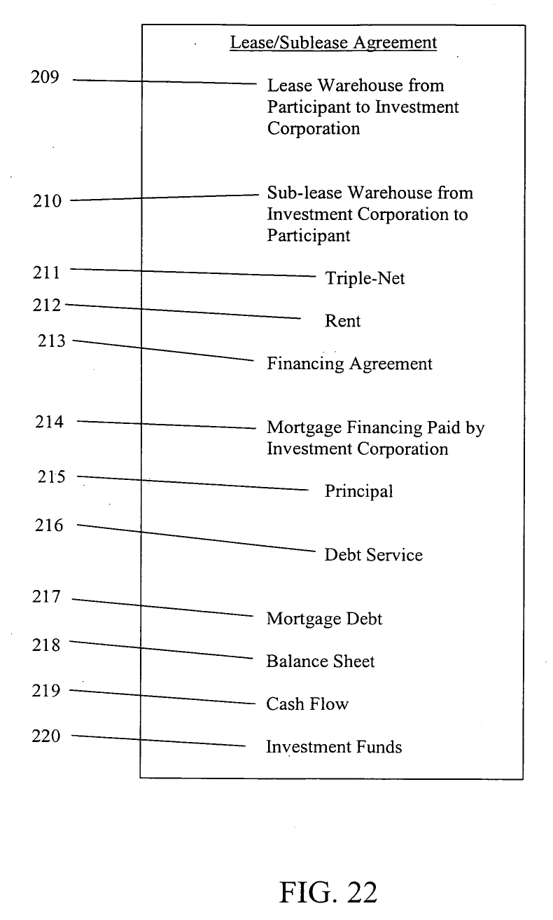

FIG. 22 illustrates an alternative embodiment of the method of the present invention in which participants 115 do not enter into sale-leaseback agreements 116. Instead, participants 115 and Corporation 112 agree to the following:

Each participant 115 enters into lease 209 with Corporation 112. Corporation 112 enters into sub-lease 210 with each participant 115 so that each participant 115 may continue to occupy and use its warehouse 111. Corporation 112 also enters into financing agreement 213 with each participant 115 in which Corporation 112 agrees to pay mortgage financing 214 including principal 215 and debt service 216 that participant 115 may have with a lending institution or that participant 115 may later acquire.

Lease 209 preferably is incorporated into a written instrument executed by participant 115 and Corporation 112. Lease 209 preferably contains customary terms and conditions found in a standard commercial lease for buildings similar to warehouses 111 with the exception that lease 209 does not require Corporation 112 to pay rent to participants 115.

Financing agreement 213 preferably is incorporated into a written instrument executed by participant 115 and Corporation 112. Financing agreement 213 may be incorporated into and made a part of lease 209. Financing agreement 213 contains terms that obligate Corporation 112 to pay mortgage financing 214 including principal 215 and debt service 216 that participant 115 may have with a lending institution or may later acquire. A unique feature of the invention is that Corporation 112 does not assume mortgage financing 214 so that participant 115 may continue to show mortgage debt 217 on balance sheet 218 of participant 115 but debt service 216 is paid by Corporation 112.

Sub-lease 210 preferably is incorporated into a written instrument executed by participant 115 and Corporation 112. Sub-lease 210 maybe incorporated into and made a part of lease 209 or financing agreement 213. Sub-lease 210, lease 209, and financing agreement 213 may also be incorporated together, preferably in one written instrument. Sub-lease 210 preferably contains customary terms and conditions found in a standard commercial sub-lease for buildings similar to warehouses 111. Sub-lease 210 may contain terms making it triple-net 211. Sub-lease 210 may contain terms obligating participant 115 to pay rent 212 to Corporation 112. Rent 212 is preferably in the range of $3.00 to $6.00 per square foot of warehouse 111 per year depending on the location of warehouse 111. However, rent 212 could be lower than $3.00 per square foot of warehouse 111 per year or higher than $6.00 per square foot of warehouse 111 per year. Rent 212 may be paid monthly, quarterly or yearly.

If participant 115 has no mortgage financing 214, participant 115 will get a larger ownership interest 144 in Corporation 112 than it otherwise would have had if warehouse 111 of participant 115 had been burdened with mortgage financing 214. Participant 115 receives a larger ownership interest 144 because appraised fair market value 118 of warehouse 111 owned by participant 115 will be greater than an appraisal of warehouse 111 that is encumbered with mortgage financing 214.

Rent 212 creates cash flow 217. Corporation 112 uses cash flow 217 to pay mortgage financing 214. Cash flow 217 also provides investment funds 220 that Corporation 112 may use to acquire and purchase income-producing investments 161 such as income producing real estate properties. Income-producing investments 161 may generate net revenue to Corporation 112. Corporation 112 may distribute portion of net earnings 162 to participants 115 as described above.

The term of each of lease 209, sub-lease 210 and financing agreement 213 is preferably between seven to ten years and more preferably, ten years with an option to renew each for another ten-year period.

While preferred embodiments of the present invention have been described, it is to be understood that the embodiments described are illustrative only and that the scope of the invention is to be defined only by the appended claims when accorded a full range of equivalence, many variations and modifications naturally occurring to those skilled in the art from a perusal hereof.

What is claimed is:

1. A method of consolidating independent owners of distribution warehouses into an investment corporation, comprising the steps of:
(a) forming said investment corporation;
(b) assembling a group of independent owners of distribution warehouses willing to participate in an ownership of said investment corporation;
(c) selecting participants in said investment corporation from said group of owners whereby each of said participants becomes a shareholder in said investment corporation and whereby each of said participants and said investment corporation agree as follows:
(i) said participant agrees to lease its warehouse to said investment corporation;
(ii) said investment corporation agrees to pay a principal and a debt service for a mortgage financing said participant has with a lending institution for said participant's warehouse;
(iii) said investment corporation agrees to sub-lease said participant's warehouse back to said participant, said sub-lease being triple-net and including a term obligating said participant to pay a rent to said investment corporation thereby providing said investment corporation with a cash flow;
(d) said investment corporation using said cash flow to pay said mortgage financing of each of said participants and to acquire at least one income producing investment capable of producing an investment revenue, said investment revenue generating net earnings for said investment corporation;
(e) said investment corporation distributing a portion of said net earnings to each of said participants in the form of a dividend.

2. The method according to claim 1, wherein said lease is for a term of at least ten years.

3. The method according to claim 1, wherein said sub-lease is for a term of at least ten years.

4. The method according to claim 1, wherein said investment corporation's agreement to pay said participant's mortgage financing is for a term of at least ten years.

5. The method according to claim 1, wherein said rent payable by each of said participants to said investment corporation is from $3.00 to $6.00 per square foot of said participant's warehouse per year.

6. The method according to claim 1, wherein said rent payable by each of said participants to said investment corporation is lower than $3.00 per square foot of said participant's warehouse per year or higher than $6.00 per square foot of said participant's warehouse per year.

7. The method according to claim 1, further comprising the step of:
said investment corporation agrees to pay a mortgage financing that said participant may later acquire from a lending institution for said participant's warehouse.

8. The method according to claim 1, wherein said lease, said sub-lease, and said agreement by said investment corporation to pay said participant's mortgage financing are contemporaneously entered into between said investment corporation and each of said participants.

9. The method according to claim 1, wherein said lease, said sub-lease, and said agreement by said investment corporation to pay said participant's mortgage financing are incorporated into a single written instrument between said investment corporation and each of said participants.

10. The method according to claim 1, wherein each of said participant's ownership interest in said investment corporation is a prorata share of outstanding shares of said investment corporation, said prorata share being calculated by dividing an appraised fair market value of said participant's warehouse by a total appraised fair market value of all of said participants' warehouses.

11. The method according to claim 1, wherein said investment corporation is a sub-chapter C corporation.

12. The method according to claim 1, wherein each of said participant's ownership interest in said investment corporation is in a form of corporate stock.

13. The method according to claim 12, further comprising the step of permitting each of said participants to divest said participant's ownership interest in said investment corporation by selling said participant's corporate stock at an independently appraised price.

14. The method according to claim 1, further comprising the step of employing a management company for said investment corporation, said management company being responsible for general and administrative operations of said investment corporation, said management company acquiring an ownership interest in said investment corporation, and said investment corporation paying said management company an annual management fee.

15. The method according to claim 14, wherein said management company has at least a 1% ownership interest in said investment corporation and each of said participant's ownership interest in said investment corporation is a prorata share of a remaining 99% interest of said investment corporation, said prorata share being calculated by dividing an appraised fair market value of said participant's warehouse by a total appraised fair market value of all of said participants' warehouses.
